(19) United States
(12) Patent Application Publication
(10) Pub. No.: US 2014/0010530 A1
(43) Pub. Date: Jan. 9, 2014

(54) OPTICAL TRANSMITTER, WAVELENGTH MULTIPLEXING TRANSMISSION DEVICE AND OPTICAL TRANSMISSION METHOD

(71) Applicant: Yuta Goebuchi, Tokyo (JP)

(72) Inventor: Yuta Goebuchi, Tokyo (JP)

(73) Assignee: NEC Corporation, Tokyo (JP)

(21) Appl. No.: 14/004,617

(22) PCT Filed: Mar. 21, 2012
(86) PCT No.: PCT/JP2012/058041

§ 371 Date: Sep. 11, 2013

(30) Foreign Application Priority Data
Mar. 25, 2011 (JP) 2011-067700

(51) Int. Cl. H04B 10/54

(52) U.S. Cl. CPC H04B 10/54
USPC 398/25; 398/184; 398/79

(57) ABSTRACT

An optical transmitter includes: a modulator; an output light monitoring unit; and a control unit. The modulator includes a dividing unit dividing light inputted to the modulator into first and second branch lights; first and second modulation units performing phase modulation for the first and second branch lights, respectively; a rotator which rotates the polarization plane of one of the first and second modulated lights; and a polarization combining unit combining the first and second modulated lights. The output light monitoring unit monitors light intensity of the output of the polarization combining unit. The control unit controls at least one of the first and second modulation units, on the basis of a monitoring result by the output light monitoring unit. The control includes a light intensity control making the light intensity of the first and/or second modulated light smaller than a maximum value of a modulation curve light intensity.

### TECHNICAL FIELD

The present invention relates to an optical transmitter, a wavelength multiplexing transmission device and an optical transmission method.

### BACKGROUND ART

As a method for controlling variation of the optical output intensity of an optical transmitter, mentioned is a control method for monitoring the optical output intensity within the optical transmitter and feeding back the monitoring result to the optical output intensity of the light source. However, an LD (Laser Diode) generally used as the light source has a property that, if the intensity of its output light changes, the wavelength of the output light also changes. Therefore, in an optical transmitter whose output light is demanded to have a stringent accuracy in wavelength, such as a coherent transmitter, for example, it is undesirable to fluctuate the optical output intensity of the light source.

On the other hand, in a case of performing optical communication by a dense wavelength division multiplexing (DWDM) method, if priority is placed on wavelength control of the light source, its optical output intensity deviates from a desired value.

As a method for solving such a problem, mentioned is a method of adding a VOA (Variable Optical Attenuator) outside an optical transmitter, as shown in FIG. 1. By this way, the fluctuation in optical output of the optical transmitter can be controlled without varying the optical output intensity of the light source. However, when this method is used in the case of performing optical communication by a wavelength division multiplexing (WDM) method, the same number of VOAs as that of transmission wavelengths are required. It results in a huge cost.

Other technologies related to the control of fluctuation in the optical output intensity of an optical transmitter are described, for example, in Patent Literatures 1 to 3.

An optical transmitter described in Patent Literature 1 performs synchronous detection using a low frequency pilot signal. Then, it controls a bias voltage applied to a bias electrode in accordance with a result of the synchronous detection.

An optical transmitter described in Patent Literature 2 monitors fluctuation of driving amplitude and, in accordance with the result, controls the driving amplitude.

An external modulator described in Patent Literature 3 includes an automatic bias control circuit (ABC circuit). The automatic bias control circuit is known as a circuit for suppressing optical output fluctuation due to a drift of an operational point on a modulation curve.

### PRIOR ART LITERATURE

### Patent Literature

Patent Literature 1: Japanese Patent Application Laid-Open Publication No. 2008-197639
Patent Literature 2: Japanese Patent Application Laid-Open Publication No. 2008-092172
Patent Literature 3: Japanese Patent Application Laid-Open Publication No. Hei 3-251815

### SUMMARY OF INVENTION

### Problem to be Solved by the Invention

In the optical transmitters and the modulator described in Patent Literatures 1 to 3, the amplitude of a driving signal or a bias voltage is adjusted in a manner to set the optical output intensity at a maximum.

For example, in a modulator which performs modulation by a QPSK (Quadrature Phase Shift Keying) modulation method, the operational point of the bias voltage is adjusted at a NULL point on a modulation curve. The driving signal amplitude is adjusted at 2Vπ. Here, Vπ is the magnitude of a voltage capable of changing an optical phase by π on the modulation curve.

However, in the case that a plurality of light beams having wavelengths different from each other are multiplexed, only with the adjustment to set the optical output intensity at a maximum alone, there occurs a difference in light intensity between the wavelengths owing to a difference in the amount of optical propagation loss between optical transmitters. To eliminate this difference, there arises a necessity for adjusting the light intensities by adding a VOA outside each of the optical transmitters. That is, to adjust the light intensity of each of the output light beams at a desired value which is lower than the maximum value, the addition of VOAs becomes necessary. It results in a huge cost.

In view of such a problem, the object of the present invention is to provide an optical transmitter which enables adjustment of the light intensity of output light at a desired value within the optical transmitter.

### Means for Solving the Problem

An optical transmitter of the present invention includes a modulator; an output light monitoring unit; and a control unit, wherein the modulator includes a dividing unit which divides light inputted to the modulator into first branch light and second branch light, a first modulation unit which performs phase modulation for the first branch light, a second modulation unit which performs phase modulation for the second branch light, a rotator which rotates the polarization plane of one of first modulated light outputted from the first modulation unit and second modulated light outputted from the second modulation unit, and a polarization combining unit which combines the first modulated light and the second modulated light; the output light monitoring unit monitors the light intensity of combined light outputted from the polarization combining unit; and the control unit controls at least one of the first modulation unit and the second modulation unit, on the basis of a result of the monitoring by the output light monitoring unit, wherein the control includes a light intensity control for making the light intensity of at least one of the first modulated light and the second modulated light smaller than a maximum value of the light intensity on a modulation curve.

A wavelength multiplexing transmission device of the present invention includes a plurality of optical transmitters and a wavelength multiplexing unit which multiplexes wavelengths outputted from the plurality of optical transmitters respectively, wherein each of the plurality of optical transmitters is the optical transmitter of the present invention.

An optical transmission method of the present invention includes: a dividing process which divides light into first branch light and second branch light; a first modulation process which performs phase modulation for the first branch light; a second modulation process which performs phase modulation for the second branch light; a rotation process which rotates the polarization plane of one of first modulated light produced by the first modulation process and second modulated light produced by the second modulation process; a polarization combining process which combines the first modulated light and the second modulated light; a monitoring process which monitors the light intensity of combined light produced by the polarization combining process; and a control process which controls at least one of a modulator for performing the first modulation process and a modulator for performing the second modulation process, on the basis of a result of the monitoring by the monitoring process, wherein the control process includes a light intensity control process of making at least one of the first modulated light and that of the second modulated light smaller than a maximum value of the light intensity on a modulation curve.

A program of the present invention which makes a computer execute a monitoring process which monitors the light intensity of combined light of first modulated light produced by phase modulation for first branch light and second modulated light, which is produced by phase modulation for second branch light, whose polarization plane is different from that of the first branch light; and a control process which controls at least one of the phase modulation for the first branch light and that of the second branch light on the basis of a result of the monitoring by the monitoring process, wherein the control process includes a light intensity control process of making at least one of the first modulated light and that of the second modulated light smaller than a maximum value of the light intensity on a modulation curve.

### Effect of the Invention

According to an optical transmitter and a control method thereof of the present invention, it becomes possible to adjust the light intensity of output light at a desired value within the optical transmitter.

### BRIEF DESCRIPTION OF THE DRAWINGS

FIG. 1 shows a configuration of an optical transmitter related to the present invention.

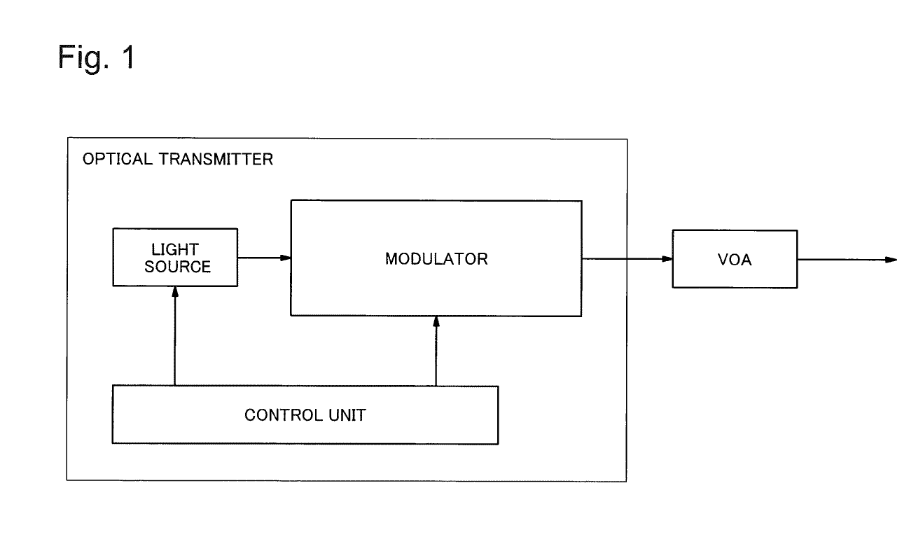

FIG. 2 shows an example of a configuration of an optical transmitter according to a first exemplary embodiment of the present invention.

FIG. 3 shows an example of operation of the optical transmitter according to the first exemplary embodiment of the present invention.

FIG. 4 shows an example of a configuration of an optical transmitter according to a second exemplary embodiment of the present invention.

FIG. 5 shows a relationship between a modulation curve for an I-arm and a Q-arm, the waveform of a pilot signal and the amplitude of a driving signal.

FIG. 6 shows an example of operation of the optical transmitter according to the second exemplary embodiment of the present invention.

FIG. 7 shows another example of a configuration of the optical transmitter according to the second exemplary embodiment of the present invention.

FIGS. 8A and 8B each show a constellation map of I and Q components, respectively.

FIG. 9 shows experimental data on a relationship between the operational point of a bias voltage and the amplitude of a pilot signal.

FIGS. 10A to 10E show experimental data on the waveform of a pilot signal and output waveforms in a case that the operational point of a bias voltage is varied.

FIG. 11 shows an example of a configuration of an optical transmitter according to a third exemplary embodiment of the present invention.

FIG. 12 shows a relationship between a modulation curve for an I-arm and a Q-arm, the waveform of a pilot signal and the amplitude of a driving signal, in a case that the amplitude of a driving signal is varied.

FIG. 13 shows an example of operation of an optical transmitter according to a fourth exemplary embodiment of the present invention.

FIG. 14 shows the light intensities of a plurality of channels having wavelengths different from each other, in WDM communication.

FIG. 15 shows an example of a configuration of a wavelength multiplexing transmission device according to a fifth exemplary embodiment of the present invention.

FIG. 16 shows another example of a configuration of the wavelength multiplexing transmission device in the fifth exemplary embodiment of the present invention.

### DESCRIPTION OF EMBODIMENTS

Exemplary embodiments of the present invention will be described with reference to drawings. However, these embodiments are not intended to limit the technical scope of the present invention.

### The First Exemplary Embodiment

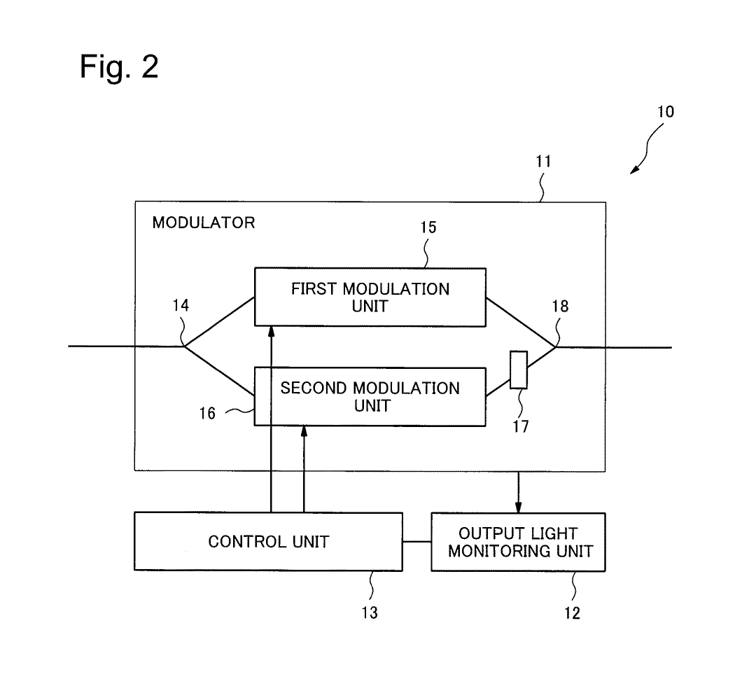

An optical transmitter according to a first exemplary embodiment of the present invention will be described using FIG. 2. FIG. 2 shows a configuration of an optical transmitter 10 according to the present exemplary embodiment.

The optical transmitter 10 includes a modulator 11, an output light monitoring unit 12 and a control unit 13. The modulator 11 includes a dividing unit 14, a first modulation unit 15, a second modulation unit 16, a rotator 17 and a polarization combining unit 18. The dividing unit 14 divides light inputted to the modulator 11 into first branch light and second branch light. The first modulation unit 15 performs phase modulation for the first branch light. The second modulation unit 16 performs phase modulation for the second branch light. The rotator 17 rotates the polarization plane of one of first modulated light outputted from the first modulation unit 15 and second modulated light outputted from the second modulation unit 16. The polarization combining unit 18 combines the first modulated light and the second modulated light.

The output light monitoring unit 12 monitors the light intensity of combined light outputted from the polarization combining unit 18.

On the basis of the monitoring result by the output light monitoring unit 12, the control unit 13 controls at least one of the first modulation unit 15 and the second modulation unit 16. Here, the control performed by the control unit 13 includes a control for setting the light intensity of at least one of the first modulated light and the second modulated light to be smaller than a maximum value of the light intensity on a modulation curve.

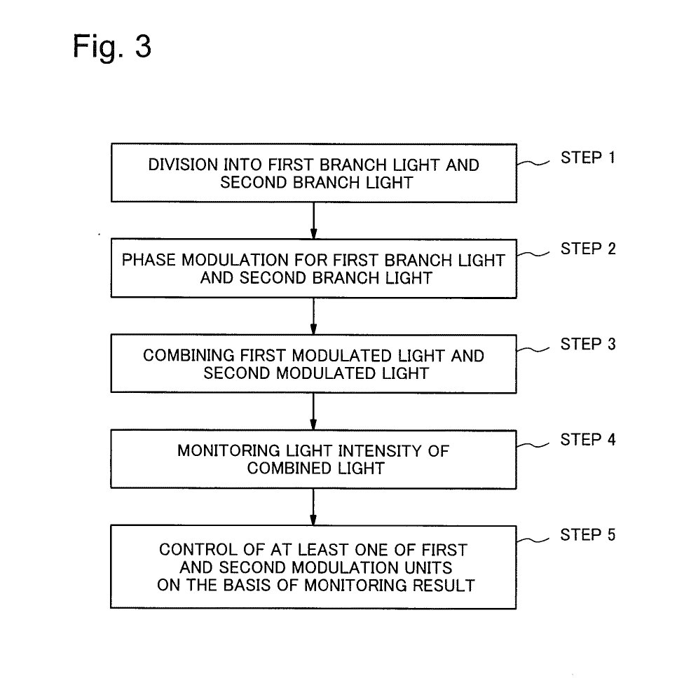

Next, operation of the optical transmitter 10 will be described using FIG. 3.

First, light inputted to the modulator 11 of the optical transmitter 10 is divided by the dividing unit 14 into first branch light and second branch light (STEP 1). Then, phase-modulated by the first modulation unit 15, the first branch light becomes the first modulated light. Also, being phase-modulated by the second modulation unit 16, the second branch light becomes the second modulated light (STEP 2). The first modulated light and the second modulated light are combined together by the polarization combining unit 18 (STEP 3). The combined light outputted from the polarization combining unit 18 is outputted from the optical transmitter 10.

Here, the output light monitoring unit 12 monitors the light intensity of the combined light outputted from the polarization combining unit 18 (STEP 4). It is also acceptable that the output light monitoring unit 12, as in a second exemplary embodiment which will be described later, monitors the light intensity of the combined light, for example, on the basis of output from a photoelectric conversion element to which the output light from the polarization combining unit 18 is inputted separately. Alternatively, it is also acceptable, as in a third exemplary embodiment which also will be described later, to monitor the light intensity of the combined light on the basis of the light intensity of the first modulated light, that of the second modulated light and information on optical loss recorded in a recording unit. Thus, it is only necessary for the output light monitoring unit 12 to be able to monitor the light intensity of the combined light outputted from the polarization combining unit 18 by any manner, and accordingly, there is no restriction on its specific configuration.

On the basis of monitoring results by the output light monitoring unit 12, the control unit 13 controls at least one of the first modulation unit 15 and the second modulation unit 16 (STEP 5).

Here, the control performed by the control unit 13 includes a control for setting the light intensity of at least one of the first modulated light and the second modulated light to be smaller than a maximum value of the light intensity on a modulation curve. That is, depending on monitoring results by the output light monitoring unit 12, the control unit 13 performs a control for setting the light intensity to be smaller than a maximum value on a modulation curve intentionally. For example, when it is found out from a monitoring result by the output light monitoring unit 12 reveals that the light intensity of the combined light is larger than a desired value, the control unit 13 can reduce the light intensity of the first modulated light by controlling the first modulation unit 15. Alternatively, the control unit 13 can reduce the light intensity of the second modulated light by controlling the second modulation unit 16. Still alternatively, the control unit 13 can control both of the first modulation unit 15 and the second modulation unit 16. Thus, the control unit 13 reduces the light intensity of the combined light by reducing the light intensity of at least one of the first modulated light and the second modulated light.

In this way, according to monitoring results by the output light monitoring unit 12, the optical transmitter 10 can reduce the light intensity of the combined light outputted from the polarization combining unit 18 within the optical transmitter 10.

Then, by repeating the processes in the STEPs 1 to 5, the light intensity of output light from the optical transmitter 10 can be converged at a desired value.

In this way, the optical transmitter 10 according to the present exemplary embodiment can adjust the light intensity of its output light at a desired value by controlling at least one of the first modulation unit 15 and the second modulation unit 16. Therefore, there is no necessity for adding a VOA outside the optical transmitter 10 for the purpose of setting the optical output intensity of the optical transmitter 10 at a desired value. Similarly, there is no necessity for providing a VOA for the inside of the optical transmitter 10. As a result, according to the present exemplary embodiment, it becomes possible to reduce the component costs compared to the case that a VOA is added inside or outside the optical transmitter.

Further, in Patent Literatures 1 to 3, descriptions are given only for the control based on the light intensity of a single polarization. Accordingly, they give no consideration to optical loss occurring at the time of combining two polarizations or the like. In contrast, in the present exemplary embodiment, it is determined that the monitoring is performed on the light intensity of combined light produced by combining two polarizations. As a result, it becomes possible to precisely control the optical output intensity even in a case of performing polarization combining within the optical transmitter.

### The Second Exemplary Embodiment

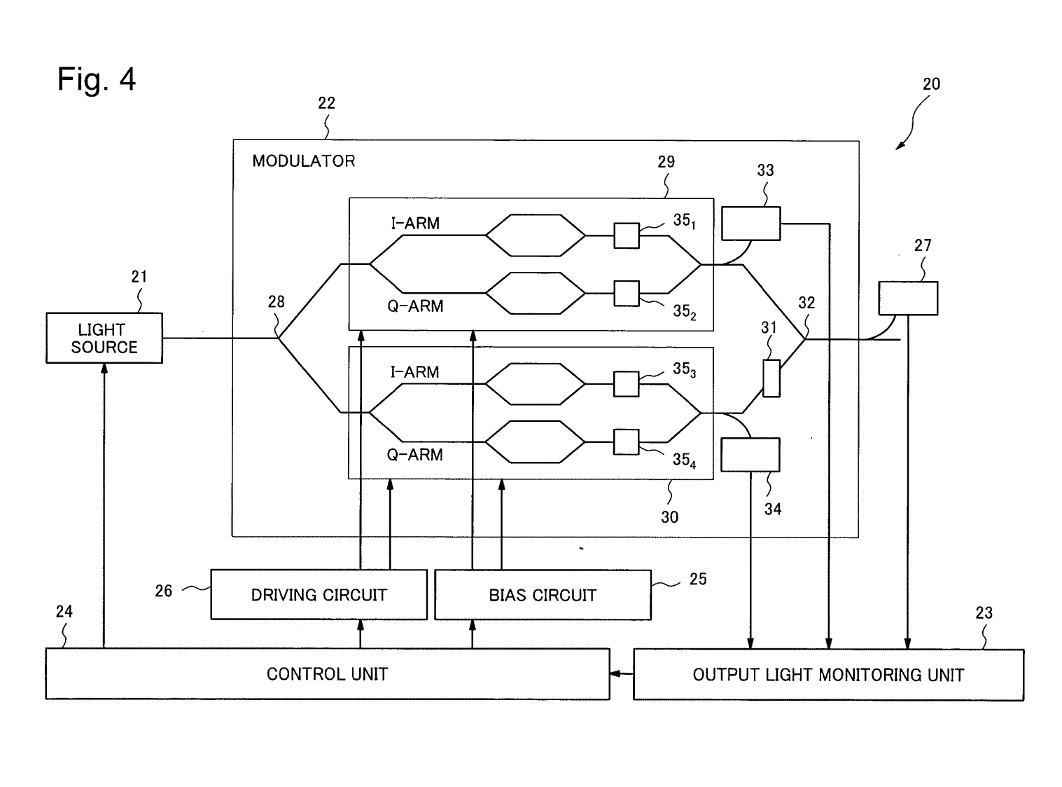

An optical transmitter according to a second exemplary embodiment of the present invention will be described using FIG. 4. FIG. 4 shows a configuration of an optical transmitter 20 according to the present exemplary embodiment.

The optical transmitter 20 according to the present exemplary embodiment includes a light source 21, a modulator 22, an output light monitoring unit 23, a control unit 24, a bias circuit 25, a driving circuit 26 and an external photoelectric element 27. The modulator 22 includes a dividing unit 28, a first modulation unit 29, a second modulation unit 30, a rotator 31, a polarization combining unit 32, a first internal photoelectric element 33 and a second internal photoelectric element 34.

The optical transmitter 20 according to the present exemplary embodiment performs optical transmission by a DP-QPSK (Dual Polarization-Quadrature Phase Shift Keying) method. The DP-QPSK method is a method which can assign 2-bit data to each of four modulated light components for two orthogonal polarizations.

Each of the first modulation unit 29 and the second modulation unit 30 includes two Mach-Zehnder type interferometers composing respectively an I-arm and a Q-arm, and it thereby performs four level phase modulation (QPSK modulation). Further, phase shifting units 35₁ to 35₄ are arranged on the output sides of the respective arms. The phase shifting units 35₁ to 35₄ give a relative phase difference to light propagating through the corresponding I-arm or Q-arm, respectively. In QPSK modulation, [θ], [θ+/2], [θ+π] and [θ+3π/2] are assigned to symbols consisting of 2-bit data of [00], [10], [11] and [01], respectively. Here, θ is an arbitrary phase.

The external photoelectric element 27 is arranged on the output side of the modulator 22, and part of combined light outputted from the polarization combining unit 32 is inputted to it. Here, the polarization combining unit 32 is referred to also as a polarization beam combiner (PBC), and is an optical coupler which combines a plurality of light beams each of which has a polarization plane with a different angle from the others.

The first internal photoelectric element 33 is arranged on the output side of the first modulation unit 29, and part of the first modulated light outputted from the first modulation unit 29 is inputted to it. The second internal photoelectric element 34 is arranged on the output side of the second modulation unit 30, and part of the second modulated light outputted from the second modulation unit 30 is inputted to it. Here, each of the external photoelectric element 27, the first internal photoelectric element 33 and the second internal photoelectric element 34 is, for example, a photoelectric conversion element such as a PD (Photo Diode).

The output light monitoring unit 23 monitors the light intensity of the combined light on the basis of output from the external photoelectric element 27. It also monitors the light intensity of the first modulated light on the basis of output from the first internal photoelectric element 33. It further monitors the light intensity of the second modulated light on the basis of output from the second internal photoelectric element 34.

The control unit 24 controls the light source 21, the bias circuit 25 and the driving circuit 26. Here, the control unit 24 according to the present exemplary embodiment controls bias voltages applied to the respective arms of the first modulation unit 29 and the second modulation unit 30, by controlling the bias circuit 25 on the basis of a monitoring result by the output light monitoring unit 23.

The bias circuit 25 applies bias voltages to the first modulation unit 29 and the second modulation unit 30. Specifically, the bias circuit 25 applies the bias voltages respectively to the I-arms, the Q-arms and the phase shifting units 35₁ to 35₄, which are included in the first and the second modulation units 29 and 30.

The driving circuit 26 inputs driving signals to the first modulation unit 29 and the second modulation unit 30. Specifically, the driving circuit 26 inputs the driving signals respectively to the I-arms and the Q-arms included in the first and the second modulation units 29 and 30.

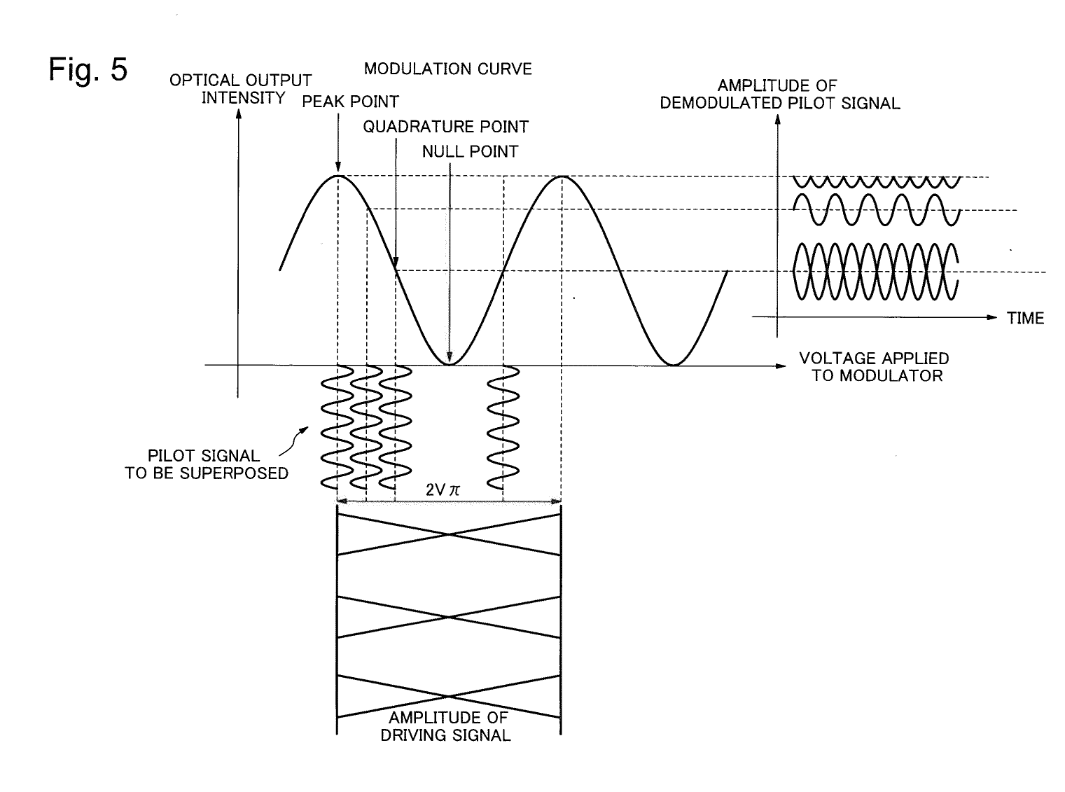

A description will be given, using FIG. 5, of a relationship between a modulation curve, a pilot signal waveform and the amplitude of a driving signal, with respect to the I-arms and Q-arms of the first and the second modulation units 29 and 30.

First, a graph showing a modulation curve for the arms of the modulator 22 will be described. The vertical axis of this graph represents the optical output intensity of output light beams from the respective arms. The horizontal axis represents the magnitude of bias voltages applied to the respective arms of the modulator 22. In the QPSK modulation method, an input signal is generally modulated by a driving signal with an amplitude of 2Vπ on this modulation curve. Here, Vπ is assumed to be the magnitude of a voltage which can change an optical phase by π on the modulation curve. In FIG. 5, also shown is a relationship between the amplitude of a driving signal and the modulation curve. This graph that the light intensities of output light beams can be controlled by controlling the operational points of bias voltages inputted to the respective arms of the modulator 22.

Further, according to the present exemplary embodiment, a pilot signal having a certain frequency and a certain amplitude is superposed on each of the bias voltages applied to the respective arms. Then, the output light monitoring unit 23 detects a demodulated pilot signal from output of the first internal photoelectric element 33. Specifically, the output light monitoring unit 23 eliminates a DC (Direct Current) component from an electrical signal outputted from the first internal photoelectric element 33, and extracts only an AC (Alternate Current) component. In this way, the output light monitoring unit 23 detects a demodulated pilot signal. Similarly, the output light monitoring unit 23 detects a demodulated pilot signal from output of the second internal photoelectric element 34. In FIG. 5, also illustrated are a waveform of the pilot signal superposed on bias voltages and waveforms of demodulated pilot signals.

FIG. 5 shows that the amplitude of a demodulated signal becomes smallest when the bias voltage and the driving signal amplitude are controlled in a manner to set the optical output intensity at a maximum (PEAK point). That is, when the operational point of the bias voltage is adjusted to be set at a NULL point on the modulation curve and the amplitude of the driving signal is set at 2Vπ, the amplitude of a demodulated pilot signal becomes smallest, and the optical output intensity becomes largest. In other words, by controlling the bias voltage and the driving voltage amplitude in a manner to have the amplitude of a demodulated pilot signal become smallest, the optical output intensity is set at a maximum. It is also shown that, when the bias voltage is controlled in a manner to set the optical output intensity at an intermediate (QUADRATURE point) between the maximum (PEAK point) and the minimum (NULL point), the amplitude of a demodulated pilot signal becomes largest. For example, shifting the operational point of the bias voltage by Vπ/2 from the NULL point without changing the amplitude of the driving signal from 2Vπ, the amplitude of a demodulated pilot signal becomes largest. Here, the phase of a demodulated pilot signal differs depending on whether the operational point of the bias voltage is shifted leftward or rightward from the NULL point. That the operational point of the bias voltage is shifted leftward from the NULL point means that the shift occurs in the direction of decreasing the bias voltage. That the operational point of the bias voltage is shifted rightward from the NULL point means that the shift occurs in the direction of increasing the bias voltage. That is, by detecting the amplitude and phase of a demodulated pilot signal, it is possible to determine in which direction and by what amount the operational point of the bias voltage is shifted from the NULL point.

Next, operation of the optical transmitter 20 will be described.

First, light outputted from the light source 21 of the optical transmitter 20 is divided by the dividing unit 28 into first branch light and second branch light.

The first branch light is inputted to the first modulation unit 29. Then, the first branch light inputted to the first modulation unit 29 propagates through the I- and Q-arms included in the first modulation unit 29, where the first branch light is phase-modulated in each of the arms. There, to the I- and Q-arms of the first modulation unit 29, respective bias voltages outputted from the bias circuit 25 and respective driving signals outputted from the driving circuit 26 are inputted.

By being phase-modulated by the first modulation unit 29, the first branch light becomes first modulated light and then outputted from the first modulation unit 29. At that time, part of the first modulated light is inputted to the first internal photoelectric element 33. The first internal photoelectric element 33 converts the optical signal of the inputted first modulated light into an electrical signal.

On the basis of output of the first internal photoelectric element 33, the output light monitoring unit 23 monitors the light intensity of the first modulated light and inputs the monitoring result to the control unit 24. Specifically, by extracting an AC component of the electrical signal outputted from the first internal photoelectric element 33, the output light monitoring unit 23 detects the amplitude and phase of a demodulated pilot signal. Here, the output light monitoring unit 23 monitors the light intensity of the first modulated light using the relationship shown in FIG. 5 between the amplitude of a demodulated pilot signal and the optical output intensity. For this purpose, the output light monitoring unit 23 stores information on a relationship between a modulation curve and a pilot signal for each of the arms included in the first modulation unit 29 and in the second modulation unit 30. Specifically, the output light monitoring unit 23 stores the information on a relationship between the amplitude and phase of the pilot signal, the light intensity and the bias voltage, such as shown in FIG. 5. By this way, the output light monitoring unit 23 becomes able to monitor the light intensity of the first modulated light on the basis of information on the amplitude of a demodulated pilot signal.

On the basis of a monitoring result inputted from the output light monitoring unit 23, the control unit 24 controls the bias voltage to be applied to the first modulation unit 29. For example, when on the basis of a monitoring result by the output light monitoring unit 23, the light intensity of the first modulated light has been determined to be larger than a desired value, the control unit 24 controls the bias voltage to be applied to the first modulation unit 29 so as to reduce the light intensity. At that time, by referring to the phase of the demodulated pilot signal, the control unit 24 determines that it should control the bias voltage in which direction of increasing or decreasing.

On the other hand, the second branch light outputted from the dividing unit 28 is inputted to the second modulation unit 30. Then, the second branch light inputted to the second modulation unit 30 propagates through the I- and Q-arms included in the second modulation unit 30, where the first branch light is phase-modulated in each of the arms. There, to the I- and Q-arms of the second modulation unit 30, respective bias voltages outputted from the bias circuit 25 and respective driving signals outputted from the driving circuit 26 are inputted.

By being phase-modulated by the second modulation unit 30, the second branch light becomes second modulated light and then outputted from the second modulation unit 30. At that time, part of the second modulated light is inputted to the second internal photoelectric element 34. The second internal photoelectric element 34 converts the optical signal of the inputted second modulated light into an electrical signal.

On the basis of output from the second internal photoelectric element 34, the output light monitoring unit 23 monitors the light intensity of the second modulated light and inputs the monitoring result to the control unit 24. Specifically, by extracting an AC component of the electrical signal outputted from the second internal photoelectric element 34, the output light monitoring unit 23 detects the amplitude and phase of a demodulated pilot signal. In this way, the output light monitoring unit 23 monitors the light intensity of the second modulated light, similarly to the case of the first modulated light.

On the basis of the monitoring result inputted from the output light monitoring unit 23, the control unit 24 controls the bias voltage to be applied to the second modulation unit 30. For example, when on the basis of a monitoring result by the output light monitoring unit 23, the light intensity of the second modulated light has been determined to be larger than a desired value, the control unit 24 controls the bias voltage to be applied to the second modulation unit 30 so as to reduce the light intensity. At that time, by referring to the phase of the demodulated pilot signal, the control unit 24 determines that it should control the bias voltage in which the direction of increasing or decreasing.

The rotator 31 rotates the polarization plane of the second modulated light. Specifically, the rotator 31 rotates the polarization plane of the second modulated light to be orthogonal to the polarization plane of the first modulated light.

The first modulated light and the second modulated light are combined by the polarization combining unit 32 and then outputted from it. Part of the combined light outputted from the polarization combining unit 32 is inputted to the external photoelectric element 27. The external photoelectric element 27 converts the inputted combined light into an electrical signal.

On the basis of output from the external photoelectric element 27, the output light monitoring unit 23 monitors the light intensity of the combined light and inputs the monitoring result to the control unit 24.

Here, on the basis of the monitoring result inputted from the output light monitoring unit 23, the control unit 24 determines whether or not the light intensity of the combined light has been set at a desired value.

When the control unit 24 determines that the light intensity of the combined light has not been set at the desired value, it controls the bias voltages inputted to the first modulation unit 29 and the second modulation unit 30 by controlling the bias circuit 25. Here, the control unit 24 controls the bias voltages so that the light intensity of the combined light will be set at the desired value and the light intensity of the first modulated light and that of the second modulated light will be set at an identical value.

Here, whether or not the light intensity of the first modulated light and that of the second modulated light have been set to be identical is determined on the basis of monitoring results on the light intensity of the first modulated light and on that of the second modulated light which are inputted sequentially from the output light monitoring unit 23.

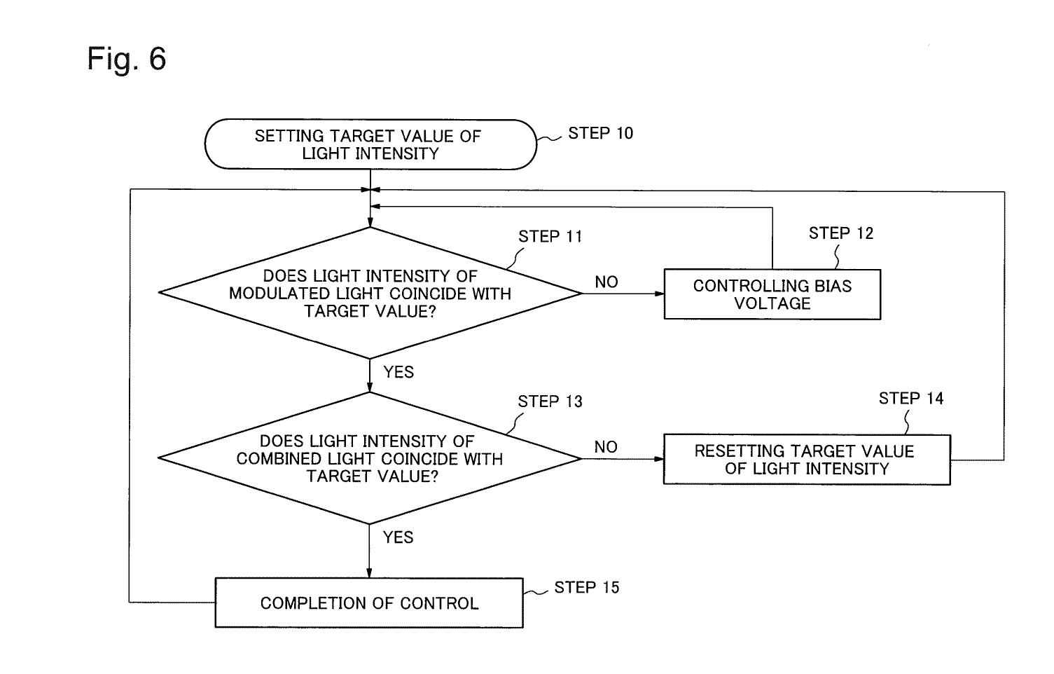

Next, a description will be given of a more specific flow of the operation of the optical transmitter 20, using FIG. 6.

First, a target value of the light intensity is set in STEP 10. That is, it is assumed that 2X is set as a target value of the light intensity of the combined light outputted from the optical transmitter 20. It is also assumed that X (=2X÷2) is set as a target value of each of the light intensity of the first modulated light and that of the second modulated light (STEP 10). Here, the amplitudes of driving signals inputted to the respective arms are assumed to be an identical value, which is assumed to be 2Vπ. Further, the operational points of the bias voltages are set at a NULL point on the modulation curve, as an initial value. It is then assumed that light from the light source 21 is inputted to the modulator 22 for which the setting above has been fixed.

The light outputted from the light source 21 is firstly divided by the dividing unit 28 into first branch light and second branch light.

Then, the first branch light is modulated by the first modulation unit 29 into first modulated light. Part of the first modulated light outputted from the first modulation unit 29 is inputted to the first internal photoelectric element 33, where it is converted into an electrical signal. From the electrical signal outputted from the first internal photoelectric element 33, the output light monitoring unit 23 extracts a pilot signal which is an AC component of the electrical signal. Subsequently, it determines the light intensity of the first modulated light on the basis of information on the amplitude and phase of the extracted pilot signal and information on a relationship between a modulation curve and a pilot signal which has been recorded in advance. The output light monitoring unit 23 notifies the control unit 24 of the information on the light intensity of the first modulated light. The control unit 24 determines whether or not the notified light intensity of the first modulated light coincides with the target value X (STEP 11).

Then, when the light intensity of the first modulated light is determined to be larger than the target value X, that is, in the case of NO at the STEP 11, the control unit 24 controls the bias voltage (STEP 12). The control of the bias voltage at that time is a control of shifting the operational point of the bias voltage from a point for light intensity to become maximum, that is, a NULL point on the modulation curve. Here, in it is determined on the basis of the phase of the demodulated pilot signal that the operational point of the bias voltage should be changed which direction of increasing or decreasing the bias voltage.

In this way, the light intensity of the first modulated light is adjusted to be equal to the target value X. If the light intensity of the first modulated light becomes equal to the target value X, the process advances to STEP 13.

In a similar way, by controlling the bias voltage applied to the second modulation unit 30 (STEPs 11 and 12), the light intensity of the second modulated light is also adjusted to be equal to the target value X. That is, the control unit 24 determines whether or not a notified light intensity of the second modulated light coincides with the target value X (STEP 11). Then, when the light intensity of the second modulated light is determined to be larger than the target value X, that is, in the case of NO at the STEP 11, the control unit 24 controls the bias voltage (STEP 12). Thus, the light intensity of the second modulated light is also adjusted to be equal to the target value X. If the light intensity of the second modulated light becomes equal to the target value X, the process advances to the STEP 13.

After the polarization plane of the second modulated light is rotated by the rotator 31, the first modulated light and the second modulated light are combined together by the polarization combining unit 32. Part of the combined light outputted from the polarization combining unit 32 is inputted to the external photoelectric element 27 and is converted into an electrical signal. On the basis of the electrical signal outputted from the external photoelectric element 27, the output light monitoring unit 23 monitors the light intensity of the combined light and inputs the monitoring result to the control unit 24.

From the inputted monitoring result, the control unit 24 determines whether or not the light intensity of the combined light coincides with the target value 2X (STEP 13). Here, it is assumed that the light intensity of the combined light is 2X−α, different from the target value 2X, and thus not coincident with the target value, that is, the case of NO at the STEP 13. The reason why the light intensity of the combined light does not become 2X even though the light intensity of the first modulated light and that of the second modulated light are both set at X is that optical loss arises such as propagation loss with a modulated polarized-wave propagating through a transmission line and insertion loss in the rotator 31 and the polarization combining unit 32.

In this case, the control unit 24 resets the target value of the first modulated light by changing it from X to X+(α/2) (STEP 14). Similarly, the target value of the second modulated light is also reset to change it from X to X+(α/2) (STEP 14).

When the reset of target values for the light intensities is completed in the STEP 14, the process returns to the STEPs 11 and 12. That is, the control unit 24 controls the bias voltages so as to set the light intensity of the first modulated light and that of the second modulated light at the reset target value.

Then, the STEPs 11 to 14 are repeated until the light intensity of the combined light is determined to be equal to the target value 2X in the STEP 13. If the light intensity of the combined light is determined to be equal to the target value 2X in the STEP 13, the control is finished (STEP 15).

However, even if the control is completed (STEP 15), the light intensity of the first modulated light, the second modulated light, or the combined light may deviate again from the target value with time. In such a case, the control unit 24 restarts the control of the bias voltages. As a reason why the light intensities may deviate again from a target value after being adjusted at the target value, mentioned is variation in the temperature of an environment in which the optical transmitter 20 is operated, for example.

As described above, the control of the bias voltages is performed by the control unit 24.

In this way, according to the present exemplary embodiment, the light intensity of output light can be adjusted at a desired value by controlling the bias voltage to be applied to the first modulation unit 29 or the second modulation unit 30. As a result, it becomes unnecessary to add a VOA inside or outside the optical transmitter 20, which leads to cost reduction. In particular, when the optical transmitter 20 according to the present exemplary embodiment is applied as an optical transmitter in a ROADM (Reconfigurable Optical Add/Drop Multiplexer) system or the like, a great amount of cost reduction can be achieved.

Moreover, besides the effect described above, the following two effects may be included in the other effects obtained by using the optical transmitter 20 of the present exemplary embodiment.

Firstly, when the optical transmitter 20 according to the present exemplary embodiment is employed as a coherent optical transmitter, characteristics of an optical receiver in the coherent communication can be made stable.

In a coherent optical transmitter performing QPSK modulation which is generally available in the current market, a specification of optical output variation is ±3 to ±4 dB, taking into account also output variation in EOL (End of Life). This value is fairly larger compared to a specification of optical output variation in a modulator of an IM-DD (Intensity Modulation-Direct Detection) method. Accordingly, when a coherent optical transmitter performing QPSK modulation is used, the largeness of its output variation causes degradation in reception characteristics of an optical receiver. In contrast, when the optical transmitter according to the present exemplary embodiment is used, it becomes possible to control its optical output intensity to be equal to a desired value within the optical transmitter. As a result, according to the optical transmitter 20 according to the present exemplary embodiment, even when it is applied to coherent communication, it becomes possible to reduce optical output variation of the coherent transmitter without adding a VOA outside the optical transmitter. Accordingly, reception characteristics of an optical receiver can be made stable.

Secondly, by using of the optical transmitter 20 according to the present exemplary embodiment, it becomes possible to suppress the difference in light intensity between polarizations. It is determined here that the difference in light intensity between polarizations is referred to hereafter as a deviation between polarizations.

Generally, when polarization combining is carried out after the light is divided and subsequently modulated, a deviation between polarizations is generated owing to the difference in propagation loss between the polarizations or the like. An example of a deviation between polarizations is the difference in actual light intensity between the first modulated light and the second modulated light if the control is performed so that the light intensity of the first modulated light and that of the second modulated light may be set at a maximum respectively.

If the deviation between polarizations is large, it causes degradation in reception sensitivity at the time of receiving transmitted output light by an optical receiver. Therefore, the deviation between polarizations is desired to be as small as possible. In this respect, according to the present exemplary embodiment, the light intensity of the first modulated light and that of the second modulated light are monitored by using the first internal photoelectric element 33 and the second internal photoelectric element 34, respectively. Accordingly, the deviation between polarizations can be suppressed by setting target values of the light intensities of the respective modulated light beams at an identical value.

Here, although it has been determined that, in the present exemplary embodiment, the light intensities of the first and the second modulated light beams are monitored by detecting the amplitude of a pilot signal, it is not the only way. That is, it may be determined that the light intensities of the output light beams are monitored by extracting a DC component, instead of an AC component, of each of the electrical signals outputted from the first internal photoelectric element 33 and the second internal photoelectric element 34.

Further, although it has been determined that, in the present exemplary embodiment, target values of the light intensities of the first and the second modulated light beams are set at an identical value, it is not the only way. That is, target values of the light intensities of the first and the second modulated light beams may be different from each other if the difference is not so large as it generates degradation in reception sensitivity at the receiver side. For example, it may be determined that, if a deviation between the light intensity of the combined light and its target value is minute in the STEP 13, only either one of the target values for the first and the second modulated light beams is changed.

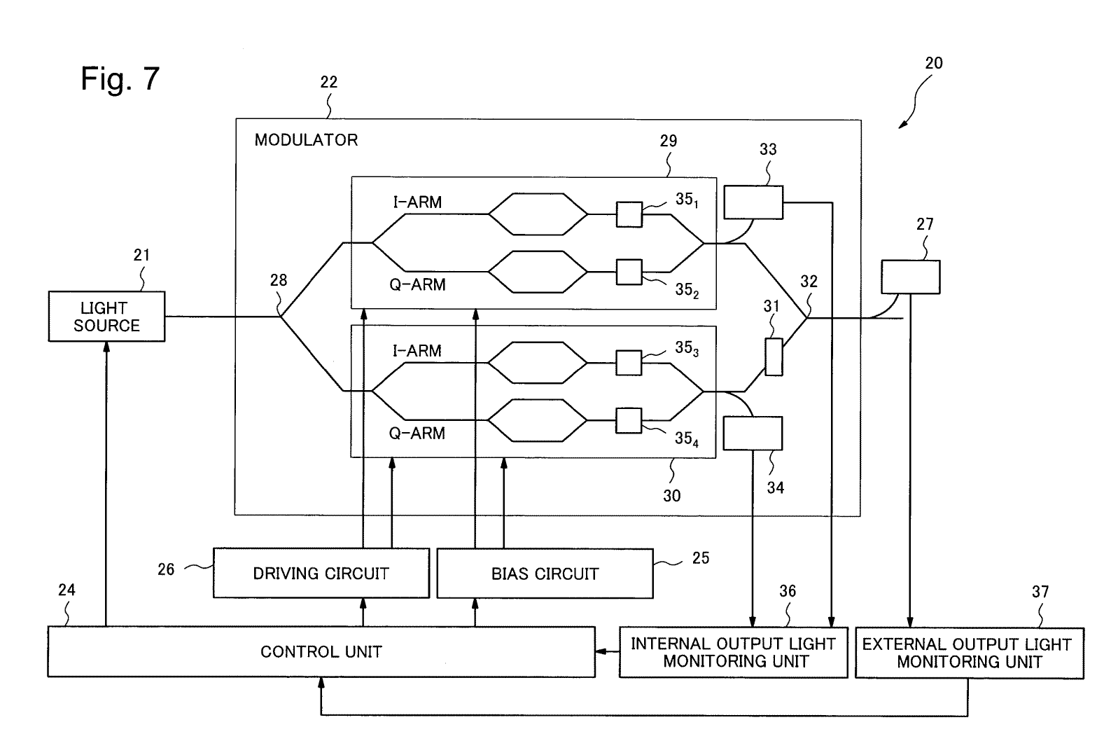

Further, although it has been determined that, in the present exemplary embodiment, the single output light monitoring unit 23 monitors the light intensities of the first and the second modulated light beams and the combined light, on the basis of outputs from the first internal photoelectric element 33, second internal photoelectric element 34 and the external photoelectric element 27, respectively, it is not the only way. For example, it may be determined that, as shown in FIG. 7, the monitoring operation is separately performed by an internal output light monitoring unit 36, to which the output from the first internal photoelectric element 33 and the second internal photoelectric element 34 is inputted, and an external output light monitoring unit 37, to which the output from the external photoelectric element 27 is inputted.

Further, although it has been determined that, in the present exemplary embodiment, the output light monitoring unit 23 stores information on a relationship between a modulation curve and a pilot signal for the modulator in each arm, it is not the only way. For example, it may be determined that the control unit 24 stores the information.

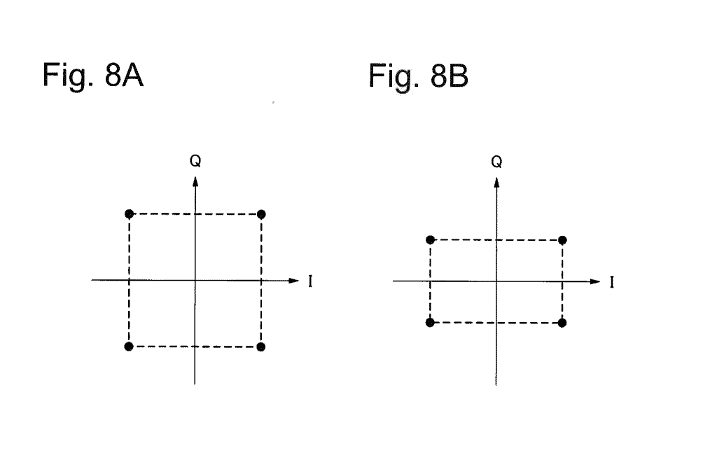

Here, in controlling the first modulation unit 29 or the second modulation unit 30, it is preferable to adjust the light intensities of output light from the I-arm and the Q-arm to be equal to each other. That is, it is preferable to control the first modulation unit 29 or the second modulation unit 30 keeping balance between the I and Q components, as a constellation map shown in FIG. 8A. The reason is because, if the light intensity of output light from the I-arm is largely different from that of output light from the Q-arm, the balance between the I and Q components is lost, as shown in FIG. 8B, and the orthogonality of optical signals is degraded.

Here, in order to adjust the light intensities of output light from the I-arm and that from the Q-arm to be equal to each other, it is only necessary, for example, that the control unit 24 controls the first modulation unit 29 or the second modulation unit 30 with reference to modulation curves for the respective arms.

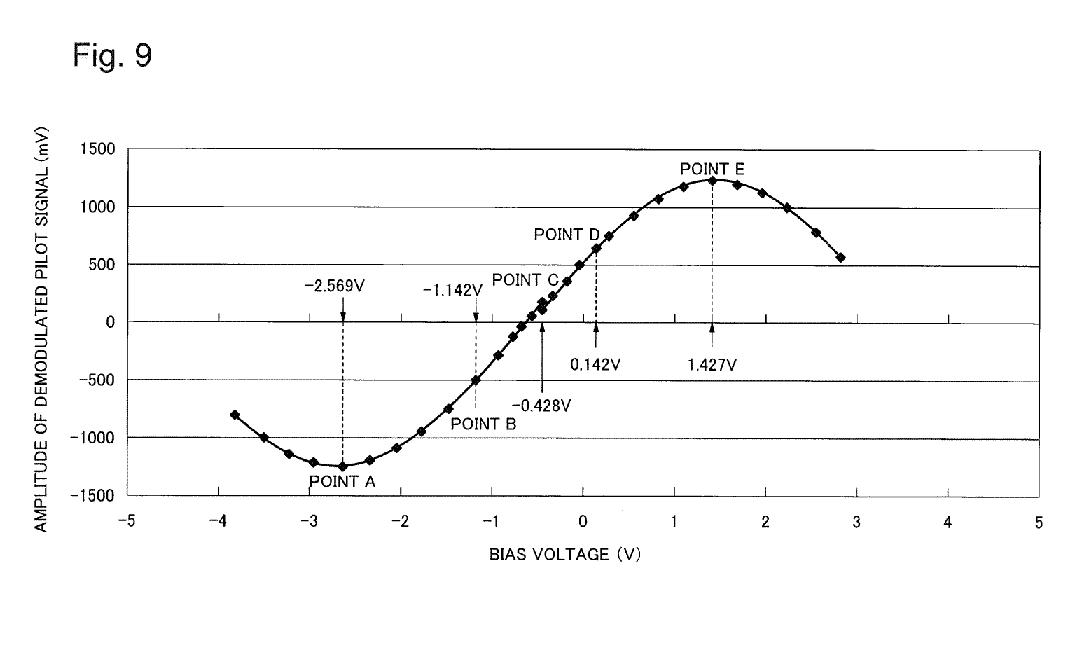

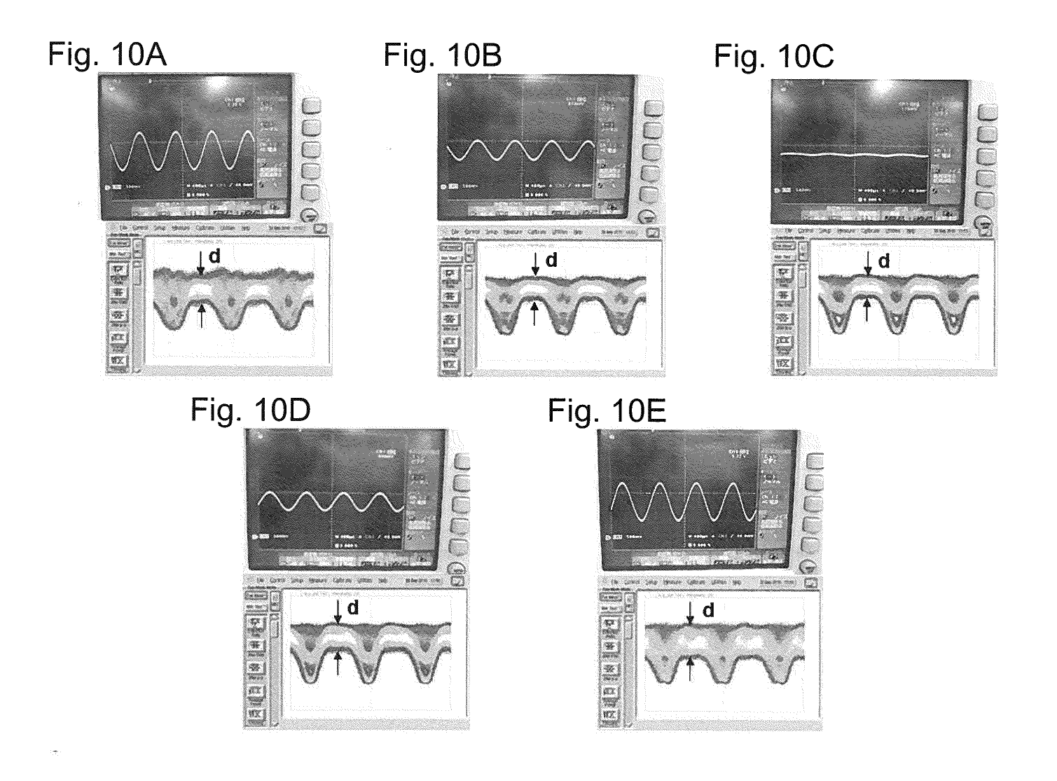

It is generally considered to be undesirable that operational points of the bias voltages deviate from a NULL point, that is, a point giving a maximum optical output intensity, because it leads to signal degradation. In the case of an NRZ (Non-Return-to-Zero) method, it is considered to be undesirable that operational points of the bias voltages deviates from a QUADRATURE point, that is, a point giving a maximum optical output intensity, because it leads to signal degradation. For this reason, in the optical transmitters and the modulator described in Patent Literatures 1 to 3, the magnitude of each bias voltage is controlled so as to be set at a value giving a maximum optical output intensity. However, according to the present exemplary embodiment, it has been determined that controls for setting the optical output intensity of the optical transmitter at a predetermined value includes a control for intentionally deviating operational points of the bias voltages from a point giving a maximum optical output intensity. The reason will be described below on the basis of experimental data shown in FIGS. 9 and 10.

FIG. 9 shows is a relationship between bias voltages applied to I- and Q-arms of an LN modulator used for a QPSK modulation method and the amplitude of a demodulated pilot signal. The amplitude and the frequency of the pilot signal superposed on the bias voltages are set at 120 mVpp and 1 kHz, respectively. Here, a position at which the amplitude of a demodulated pilot signal becomes zero (point C) in FIG. 9 represents a case where the operational point of a bias voltage is set at NULL point on the modulation curve.

FIGS. 10A to 10E show waveforms of demodulated pilot signals and signal waveforms of output light beams in cases where the bias voltage is adjusted at values corresponding to points A to E in FIG. 9, respectively. A diagram in the upper area in each of FIGS. 10A to 10E shows the waveform of a demodulated pilot signal, and a diagram in the lower area in each figure shows the signal waveform of output light. Bias voltages corresponding to the points of A to E in FIG. 9 are −2.569 V (point A), −1.142 V (point B), −0.428 V (point C), 0.142 V (point D) and 1.427 V (point E), respectively. Represented by the deviations from the NULL point on the modulation curve, the operational points of the respective bias voltages are −Vπ/2 (point A), −Vπ/4 (point B), zero (point C), +Vπ/4 (point D) and +Vπ/2 (point E), respectively. Here, Vπ is the magnitude of a voltage necessary for changing an optical phase by π on the modulation curve. The point C is slightly deviated from a point at which the amplitude of a pilot signal becomes zero, which is owing to the accuracy of bias voltage control by the device used for this experiment. That is, the reason is as follows. It is difficult to precisely adjust of the operational point of a bias voltage to be at a NULL point on the modulation curve, and consequently there occurs a slight error.

Here, a width d is defined as the width of a horizontal bar shape which links upside-down triangle shapes and appears in each of output waveforms of output light shown in FIGS. 10A to 10E. Then, when a value of this width d is larger than in the case that the operational point of the bias voltage is set at a NULL point on the modulation curve (FIG. 10C), it turns out that signal deterioration has occurred.

From FIGS. 10B and 10D, it can be seen that values of the width d in output waveforms in the cases that the operational point of the bias voltage is shifted from that in FIG. 10C by ±Vπ/4 are rarely different from the value of the width d in FIG. 10C. That is, it can be seen that, even if the operational point of the bias voltage is shifted by ±Vπ/4 from the NULL point on the modulation curve, signal deterioration hardly occurs.

On the other hand, from FIGS. 10A and 10E, it can be seen that values of the width d in output waveforms in the cases that the operational point of the bias voltage is shifted from that in FIG. 10C by ±Vπ/2 are fairly larger compared to the value of the width d in FIG. 10C. That is, it can be seen that, if the operational point of the bias voltage is shifted by ±Vπ/2 from the NULL point on the modulation curve, signal deterioration occurs.

From the above results, it has been found that signal deterioration does not occur very often when the bias voltage is varied only within a range of ±Vπ/4 from the NULL point on the modulation curve. That is, it has been found that, even when the operational point of the bias voltage is shifted from the NULL point on the modulation curve, the light intensity can be reduced with almost no generation of signal degradation if the shift is within a range of ±Vπ/4.

For this reason, it has been determined that the control of bias voltages in the optical transmitter 20 according to the present exemplary embodiment includes a control to reduce the light intensity by intentionally shifting operational points of the bias voltage from a point giving a maximum light intensity.

By the way, the optical output intensity of a coherent optical transmitter performing modulation by a QPSK modulation method usually fluctuates by about ±3 dB. That is, when a plurality of wavelengths are multiplexed, the difference in light intensity between the light beams whose wavelengths are different from each other usually becomes up to about 6 dB. To eliminate this difference in light intensity, it is only necessary to set the light intensities of the light beams of the respective wavelengths to be equal to the light intensity of a light beam with the smallest light intensity. In this case, it is deduced that, with respect to the light beams of other wavelengths, their light intensities only need to be reduced by up to about 6 dB. Then, when each of the other light beams is combined light produced by combining two polarizations, it is further deduced that it is only necessary to reduce the light intensity of each polarization by up to about 3 dB. Further, it is deduced that, in each I-arm and each Q-arm, the light intensity only needs to be reduced by up to about 1.5 dB. Here, the maximum optical output intensity of a modulator used for a QPSK modulation method is usually equal to or larger than 20 dB. Accordingly, about 1.5 dB reduction in each arm can be sufficiently achieved by shifting the operational point of the bias voltage within a range of ±Vπ/4 from a NULL point on the modulation curve. That is, when the optical transmitter 20 according to the present exemplary embodiment is applied as a coherent optical transmitter, it becomes possible to correct the difference in light intensity between a plurality of wavelengths with almost no generation of signal degradation.

Here, although it has been determined that the optical transmitter 20 according to the present exemplary embodiment performs optical transmission by a DP-QPSK method, it is not the only way. For example, the present exemplary embodiment can be applied also to an optical transmitter which performs optical transmission by a QAM (Quadrature Amplitude Modulation) method. Here, the QAM method is a modulation method which uses a combination of phase change and amplitude change and performs quadrature phase modulation on multi-level ASK (Amplitude-shift keying) signals.

### The Third Exemplary Embodiment

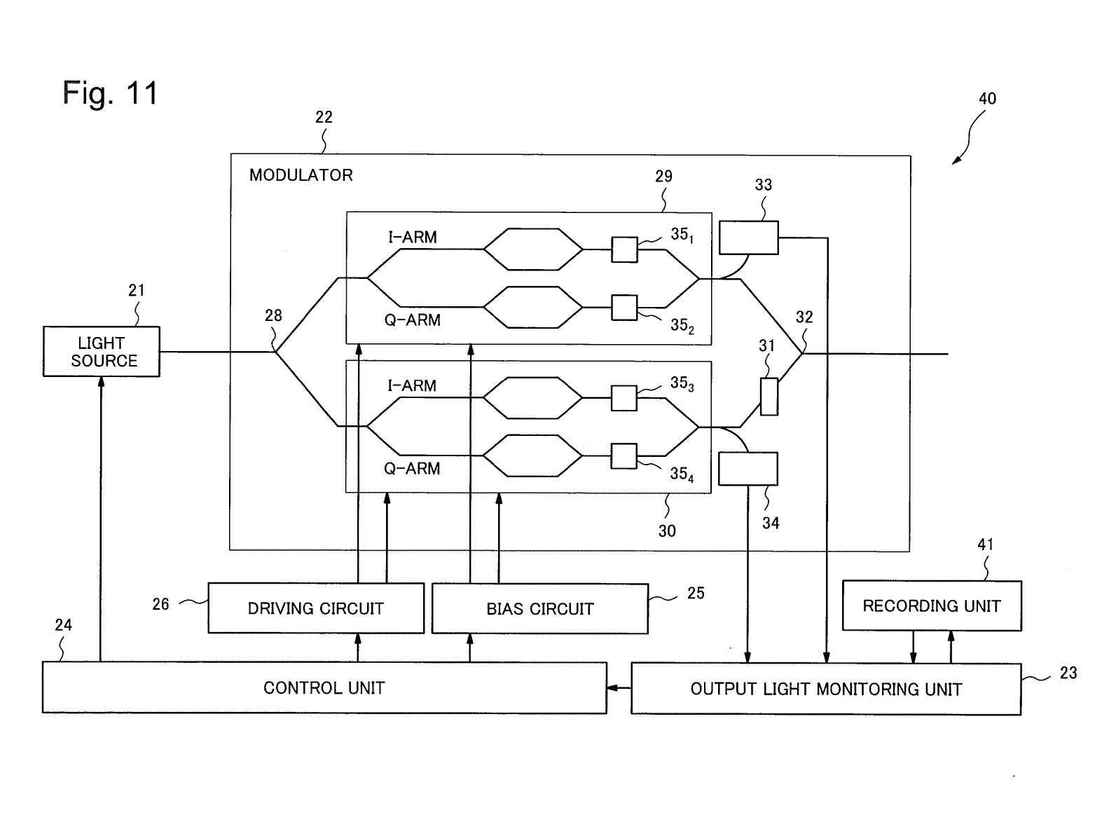

An optical transmitter according to a third exemplary embodiment of the present invention will be described using FIG. 11. FIG. 11 shows a configuration of an optical transmitter 40 according to the present exemplary embodiment.

Compared with the optical transmitter 20 in the second exemplary embodiment, the optical transmitter 40 in the present exemplary embodiment is different in that it does not include the external photoelectric element 27. The optical transmitter 40 is also different in that it includes a recording unit 41 which records information about optical loss. The recording unit 41 is, for example, a recording medium such as a ROM (Read Only Memory). The rest of the configuration is the same as that of the optical transmitter 20, and accordingly its description will be omitted.

The recording unit 41 records are information on the amount of optical loss of the first modulated light outputted from the first modulation unit 29 and information on the amount of optical loss of the second modulated light outputted from the second modulation unit 30. The information on the amount of optical loss of the first modulated light is, for example, optical loss of the first modulated light while the first modulated light is outputted from the first modulation unit 29 and then it is outputted from the polarization combining unit 32, and the quantum efficiency in the first internal photoelectric element. Similarly, the information on the amount of optical loss of the second modulated light is, for example, optical loss of the second modulated light while the second modulated light is outputted from the second modulation unit 30 and then it is outputted from the polarization combining unit 32, and the quantum efficiency in the second internal photoelectric element. It may be determined that the information on the amount of optical loss further includes the amount of insertion loss of the rotator 31 and that of the polarization combining unit 32. The amount of insertion loss of the rotator 31 and that of the polarization combining unit 32 are the amount of optical loss of the first modulated light and that of the second modulated light which are caused by inserting the rotator 31 and the polarization combining unit 32.

Next, operation of the optical transmitter 40 will be described.

Up to the process in which the control unit 24 controls the bias voltages to be applied to the first modulation unit 29 and the second modulation unit 30 on the basis of a monitoring result of the light intensities of part of the first modulated light and the second modulated light, the processes are the same as the STEPs 10 to 12 in the second exemplary embodiment, and accordingly their descriptions will be omitted. Hereinafter, a process will be described in which the optical transmitter 40 monitors the light intensity of the combined light outputted from the polarization combining unit 32.

The output light monitoring unit 23 in the optical transmitter 40 calculates the light intensity of the combined light outputted from the polarization combining unit 32 from outputs from the first internal photoelectric element 33 and the second internal photoelectric element 34 and information on the amount of optical loss recorded in the recording unit 41. That is, the light intensity of the first modulated light is calculated from the output from the first internal photoelectric element 33, and the light intensity of the second modulated light is calculated from the output from the second internal photoelectric element 34. Then, the light intensity of the combined light is calculated by subtracting the amount of optical loss recorded in the recording unit 41 from the sum of the light intensities of the first modulated light and the second modulated light. For example, the light intensities of the first modulated light and the second modulated light are both assumed to be 10 dB. Further, the information on the amount of optical loss recorded in the recording unit 41 is assumed to be the amount of optical loss of the first modulated light and that of the second modulated light which are both 0.5 dB. In this case, the output light monitoring unit 23 calculates the light intensity of the combined light as 10+10−(0.5+0.5)=19 dB.

In general, the amounts of optical loss, which occur while the first modulated light and the second modulated light are outputted respectively from the first modulation unit 29 and the second modulation unit 30 and then they are outputted from the polarization combining unit 32, are constant without depending on the light intensity of the first modulated light and that of the second modulated light, respectively. Therefore, by storing the amounts of optical loss in the recording unit 41, the light intensity of the combined light can be calculated without including the external photoelectric element 27 as the second exemplary embodiment.

After calculating the light intensity of the combined light, the output light monitoring unit 23 sends the calculation result to the control unit 24. Then, on the basis of the monitoring result on the light intensity of the combined light sent from the output light monitoring unit 23, the control unit 24 controls the first modulation unit 29 and the second modulation unit 30. The processes after the sending of the monitoring result on the light intensity of the combined light are the same as the STEPs 14 and 15 in the second exemplary embodiment, and accordingly their descriptions will be omitted.

As described above, similarly to in the second exemplary embodiment, addition of a VOA inside and outside the optical transmitter becomes also unnecessary in the present exemplary embodiment, and accordingly the cost can be reduced. Further, when the optical transmitter 40 is employed as a coherent optical transmitter, characteristics of an optical receiver in the coherent communication can be made stable. Furthermore, suppression of the deviation between polarizations becomes possible.

In addition, in the optical transmitter 40, differing from the optical transmitter 20, it is possible to monitor the light intensity of the combined light without adding the external photoelectric element 27. Accordingly, compared to the optical transmitter 20, the optical transmitter 40 makes possible further cost reduction and further size reduction of the transmitter.

Moreover, the optical transmitter 40 according to the present exemplary embodiment stores the amount of optical loss of the first modulated light and that of the second modulated light. Accordingly, the control unit 24 can set target values of the light intensity of the first modulated light and that of the second modulated light depending on the difference in optical loss between the first modulated light and the second modulated light. For example, the amount of optical loss occurring in the first modulated light and that occurring in the second modulated light are assumed to be 1 dB and 1.5 dB, respectively. In this case, taking into account the 0.5 dB difference between the amounts of optical loss of the two modulated light beams, the control unit 24 sets a target value of the light intensity of the first modulated light and that of the second modulated light to be different from each other by 0.5 dB. That is, a target value of the light intensity of the first modulated light is made smaller by 0.5 dB than that of the second modulated light. In this way, it becomes possible for the optical transmitter 40 according to the present exemplary embodiment becomes able to further reduce the deviation between polarizations with respect to the first modulated light and the second modulated light included in the combined light.

Here, although it has been determined to include the recording unit 41 according to the present exemplary embodiment, it is not the only way. For example, it may be determined that the output light monitoring unit 23 includes a recording unit inside and thereby stores information on optical loss. Alternatively, it may be determined that the control unit 24 includes a recording unit inside and thereby stores information on optical loss.

Further, also in the present exemplary embodiment, it is desirable to set the light intensities of output light beams from I- and Q-arms to be equal to each other, similarly to the second exemplary embodiment.

### The Fourth Exemplary Embodiment

An optical transmitter according to a fourth exemplary embodiment of the present invention will be described below. Compared with the optical transmitter 20 in the second exemplary embodiment, an optical transmitter 50 in the present exemplary embodiment has the same configuration but its operation is different.

That is, the optical transmitter 20 of the second exemplary embodiment has been configured such that the control unit 24 controls the light intensities of the first modulated light, the second modulated light and the combined light by controlling the bias voltages applied to the first modulation unit 29 and the second modulation unit 30. On the other hand, in the optical transmitter 50 of the present exemplary embodiment, the control unit 24 controls the light intensities of the first modulated light, the second modulated light and the combined light by controlling the amplitudes of the driving signals inputted to the first modulation unit 29 and the second modulation unit 30.

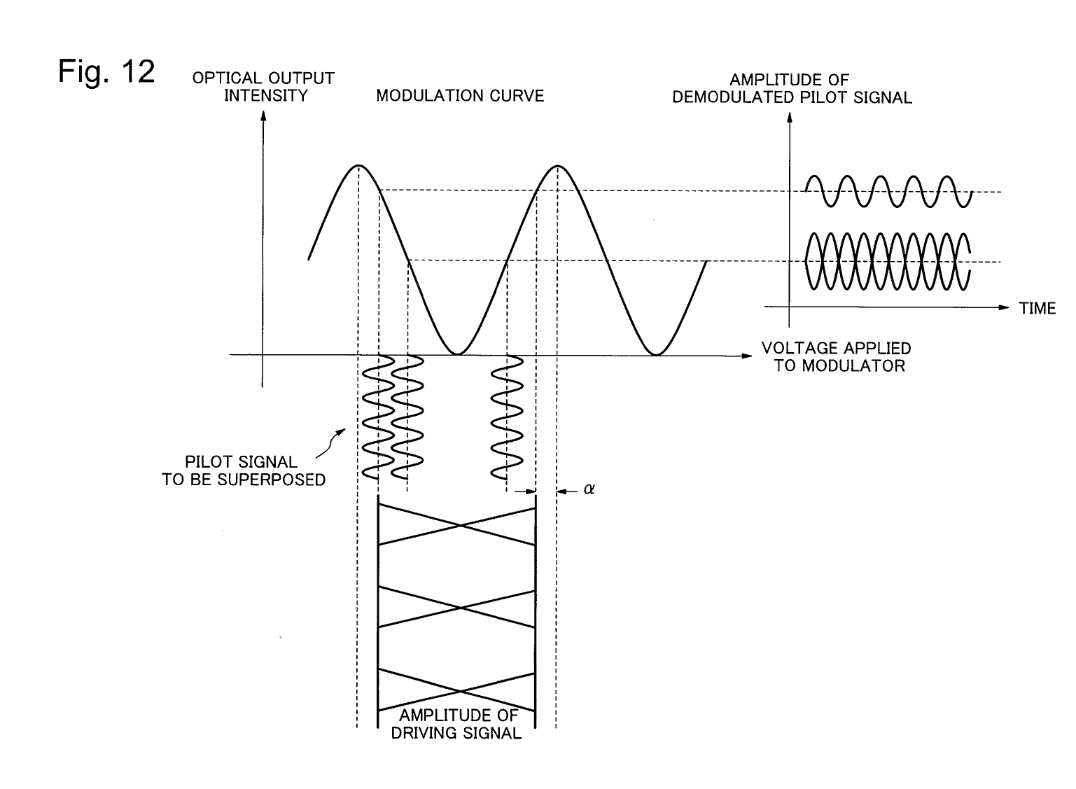

It will be explained using FIGS. 5 and 12 that the light intensities of the output light beams can be controlled by controlling the amplitudes of the driving signals.

FIG. 5 shows, as already described, a graph of a modulation curve for the I- and Q-arms of the modulator 22. In FIG. 5, the amplitude of the driving signal is also illustrated and is set at 2Vπ there. On the other hand, FIG. 12 shows a case where the amplitude of the driving signal is set at a value which is smaller than 2Vπ by α. Here, the operational point of the bias voltage is assumed to be set at a NULL point of the modulation curve, similarly to the case shown in FIG. 5.

From FIG. 12, it can be seen that, by reducing the amplitude of the driving signal from 2Vπ by α, the light intensity of output light is reduced and the amplitude of a demodulated pilot signal is increased. That is, it is understood that the light intensity of output light can be controlled by controlling the amplitude of the driving signal.

Using this principle, the optical transmitter 50 controls the light intensity of the first modulated light, that of the second modulated light and that of the combined light, by controlling the amplitudes of the driving signals to be inputted to the first modulation unit 29 and the second modulation unit 30.

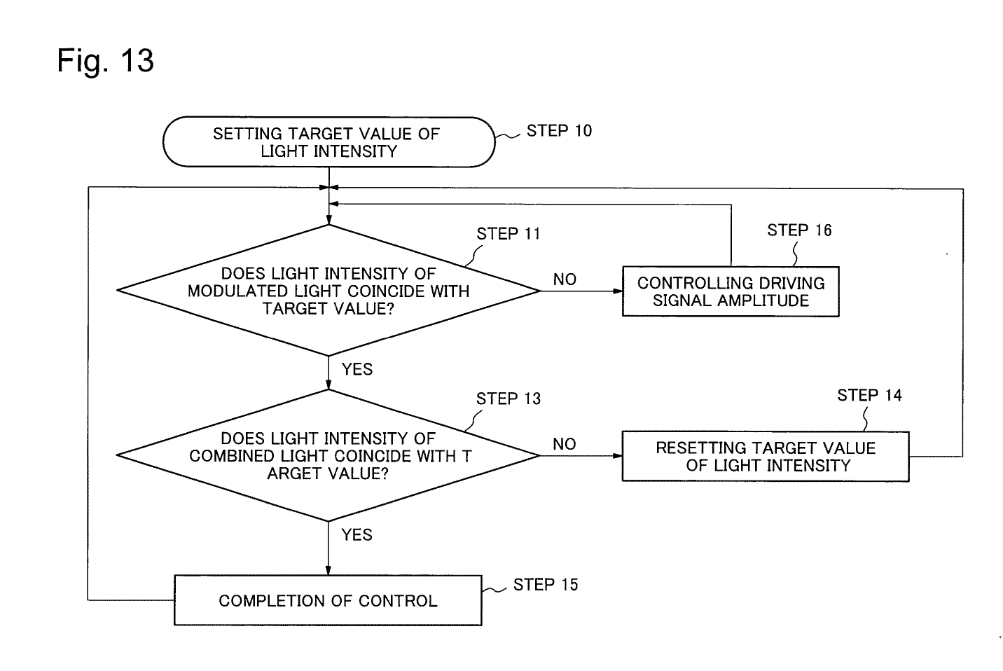

Next, operation of the optical transmitter 50 will be described in detail, using FIG. 13. Here, because STEPs 10, 11 and 13 to 15 in FIG. 13 are the same as those in the operation of the optical transmitter 20, their descriptions will be omitted. Hereinafter, STEP 16, which is a different operation from that of the optical transmitter 20, will be described.

In the STEP 11, when the light intensity of the first modulated light has been determined not to be coincident with a target value, the control unit 24 controls the amplitude of the driving signal to be inputted to the first modulation unit 29 (STEP 16). For example, when the light intensity of the first modulated light has been determined to be larger than the target value, the control unit 24 performs control of shifting the amplitude of the driving signal from 2Vπ. Here, the control unit 24 stores a relationship between the amplitude of the driving signal and the amplitude and phase of the pilot signal, such as shown in FIGS. 5 and 12. From the relationship, the control unit 24 determines a value of the amplitude of the driving signal to make the light intensity of the first modulated light equal to the target value, and notifies it to the driving circuit 26. Then, the driving circuit 26 inputs to the first modulation unit 29 a driving signal having the amplitude notified from the control unit 24. Here, the amplitude of the driving signal outputted from the driving circuit 26 can be monitored by using a peak detection function held by the driving circuit 26.

In this way, the control unit 24 controls the first modulation unit 29. Similarly, the control unit 24 controls the second modulation unit 30 so as to make the light intensity of the second modulated light equal to the target value.

As described above, the optical transmitter 50 in the present exemplary embodiment can set the light intensity of output light from the optical transmitter 50 at a desired value by controlling the amplitudes of the driving signals to be inputted to the first modulation unit 29 and the second modulation unit 30.

As a result, also in the present exemplary embodiment, the same effect as that of the second exemplary embodiment is achieved. That is, addition of a VOA inside and outside the optical transmitter 20 becomes unnecessary, and the cost can be reduced. In addition, when the optical transmitter 50 is employed as a coherent optical transmitter, characteristics of an optical receiver in the coherent communication can be made stable. Furthermore, the deviation between polarizations can be suppressed.

In general, deviation of the amplitudes of the driving signals from a value giving a maximum optical output intensity, which is 2Vπ in the present case and is Vπ in the case of an NRZ method, is considered to be undesirable, because it leads to signal degradation. For this reason, in the optical transmitters and the modulator described in Patent Literatures 1 to 3, control is performed such that the magnitude of each amplitude of the driving signals is set at a value giving a maximum optical output intensity. However, in the present exemplary embodiment, it has been determined that the control for setting the optical output intensity of the optical transmitter at a predetermined value includes a control of intentionally shifting the amplitudes of the driving signals from a value giving a maximum optical output intensity.

This is because, if the amplitudes of the driving signals are changed within a certain range, the light intensity can be reduced with almost no generation of signal degradation.

The range that the amplitudes of the driving signals can be changed with almost no generation of signal degradation is a range within ±Vπ/2 from amplitude values of the driving signals giving a maximum optical output intensity.

### The Fifth Exemplary Embodiment

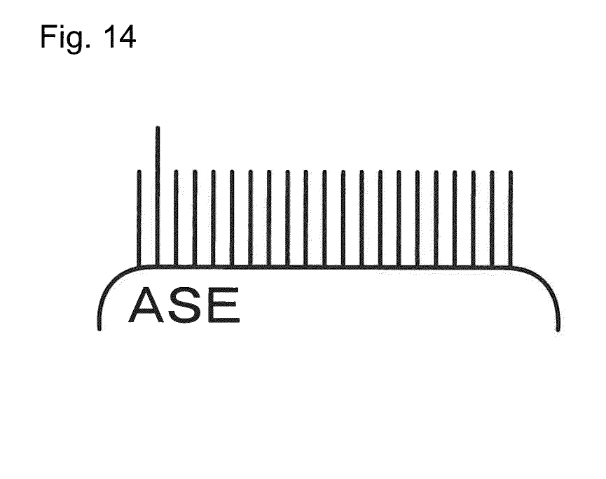

By the way, when a coherent optical transmitter is applied to a WDM system, if the optical output intensity of the coherent optical transmitter fluctuates, deviation in level between the channels of a WDM signal, that is, a tilt, increases. FIG. 14 shows the light intensities of a plurality of channels having wavelengths different from each other. In FIG. 14, a second channel from the left has a larger light intensity compared to the other channels, which indicates occurrence of the tilt.

In a general long-haul WDM system, optical amplification is performed in a multi-stage by using a plurality of EDFAs (Erbium Doped Fiber Amplifiers). Accordingly, increase of the tilt has a great influence on the system. In particular, the transmission distance and the transmission bandwidth in the WDM system are greatly influenced. This is because, an assurance of an optical signal to noise ratio (OSNR: Optical Signal to Noise Ratio) is a key point for maintaining a transmission quality, and an OSNR of each channel is changed greatly by increase of the tilt.

Here, as a light source of a WDM signal, ASE (Amplified Spontaneous Emission) light is used, for example.

In this respect, in a fifth exemplary embodiment of the present invention, a description will be given of a wavelength multiplexing transmission device capable of suppressing increase of the tilt.

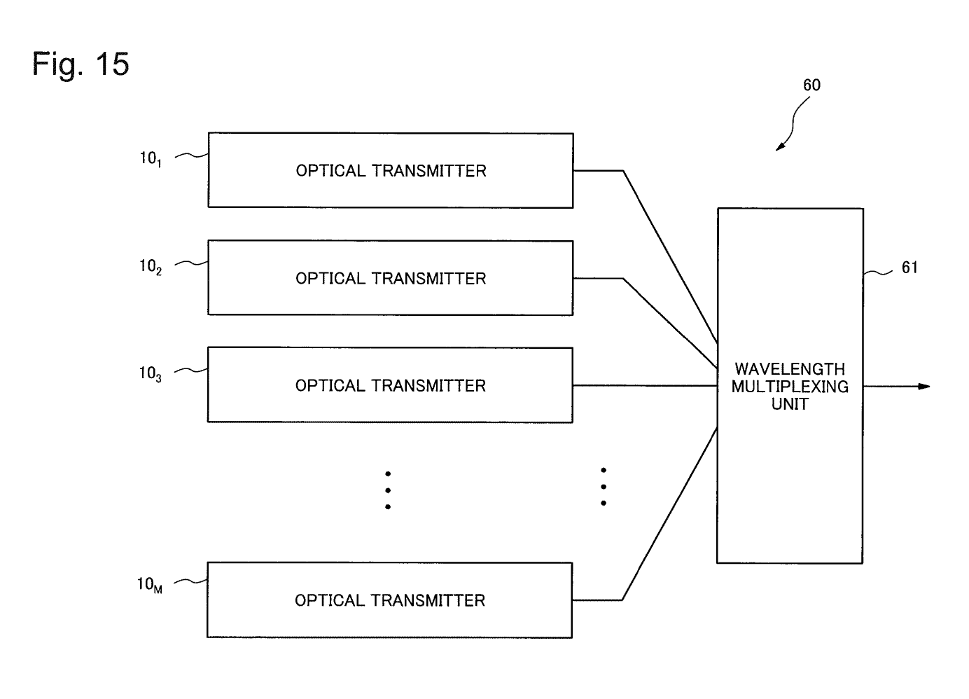

FIG. 15 shows a configuration of a wavelength multiplexing transmission device 60 according to the present exemplary embodiment. The wavelength multiplexing transmission device 60 includes a plurality of the optical transmitters 10 of the first exemplary embodiment. The plurality of the optical transmitters 10 includes in the wavelength multiplexing transmission device 60 will be referred to as optical transmitters 10₁ to 10_{M}, respectively. Each of the optical transmitters 10₁ to 10_{M} outputs a light beam with a wavelength different from the others. The wavelength multiplexing transmission device 60 further includes a wavelength multiplexing unit 61 which multiplexes the wavelengths outputted from respective optical transmitters 10₁ to 10_{M}.

Next, operation of the wavelength multiplexing transmission device 60 will be described.

First, a target value of the light intensity of the combined light is set to each of the control units included in the optical transmitters 10₁ to 10_{M}. Here, the target value to be set is assumed to be a common value for all of the optical transmitters 10₁ to 10_{M}.

Next, each control unit of the optical transmitters 10₁ to 10_{M} controls the first modulation unit and the second modulation unit on the basis of a monitoring result by the output light monitoring unit. The operation of the optical transmitters 10₁ to 10_{M} at that time is the same as the STEPs 1 to 5 described in the first exemplary embodiment. When every light intensity of the output light beams of the optical transmitters 10₁ to 10_{M} becomes equal to the target value, the control is finished.

Then, the light beams outputted from respective optical transmitters 10₁ to 10_{M} are wavelength-multiplexed by the wavelength multiplexing unit 61 and subsequently outputted from the wavelength multiplexing transmission device 60.

As described above, according to the present exemplary embodiment, the light intensities of the output light beams outputted from the plurality of optical transmitters 10₁ to 10_{M} included in the wavelength multiplexing transmission device 60 can be controlled to be set at a common target value.

Therefore, of this, according to the wavelength multiplexing transmission device 60 according to the present exemplary embodiment, suppression of increase of the tilt becomes possible. As a result, suppression of degradation in communication characteristics becomes possible.

Here, a target value of the output light set to each of the optical transmitters 10₁ to 10_{M} according to the present exemplary embodiment may be determined to be an arbitrary value, but it is not the only way. For example, it may be determined to set the target value in the following manner.

First, each of the optical transmitters 10₁ to 10_{M} is operated so that its optical output intensity may become maximum. That is, in the case that the optical transmitters 10₁ to 10_{M} perform QPSK modulation respectively, the operational points of the bias voltages applied to the respective arms are set at a NULL point of the modulation curve. Further, the amplitudes of the driving signals to be inputted to the respective arms are all set at 2Vπ.

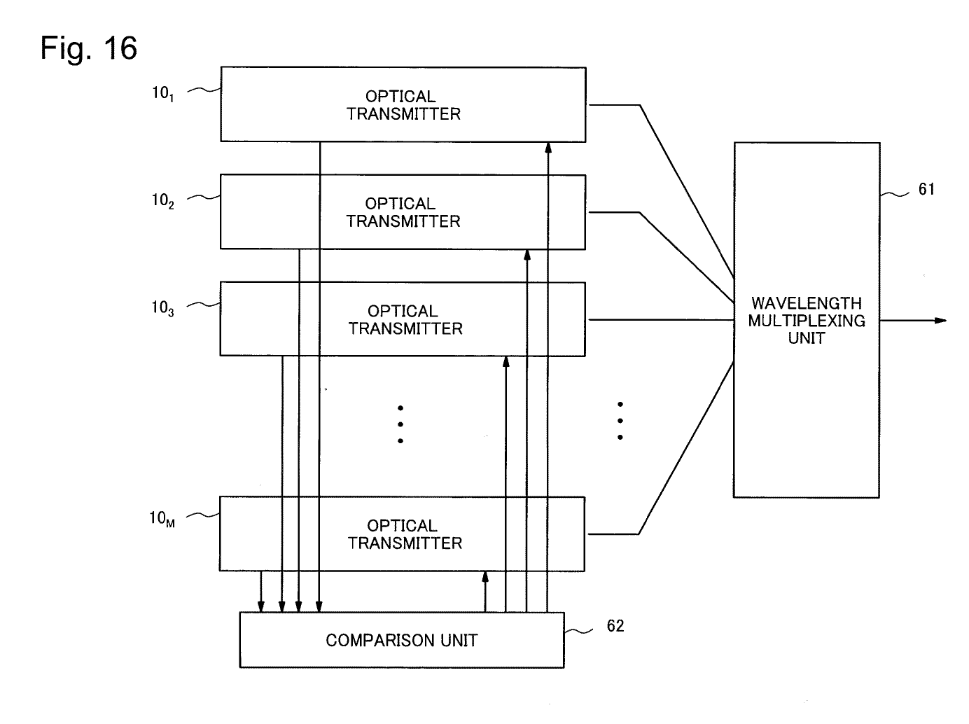

Then, from monitoring results by the output light monitoring units held by respective optical transmitters 10₁ to 10_{M}, the light intensities of output light of respective optical transmitters 10₁ to 10_{M} are compared. Accordingly, the smallest output light intensity is set as a target value for the output light intensities of the optical transmitters 10₁ to 10_{M}. That is, the optical transmitters other than one having the smallest light intensity of output light perform control for reducing the light intensity of their own output light. In the case that a target value is set in such a way, it is necessary to include a comparison unit 62 as shown in FIG. 16. To the comparison unit 62, monitoring results are inputted from the output light monitoring units 23 of respective optical transmitters 10₁ to 10_{M}. Comparing the inputted monitoring results, the comparison unit 62 determines a target value for the output light intensity. Then, the comparison unit 62 notifies the determined target value to the control units in respective optical transmitters 10₁ to 10_{M}. It may be determined that a target value of the output light intensity is set in the way just described above.

Here, although it has been determined that the wavelength multiplexing transmission device 60 of the present exemplary embodiment included a plurality of the optical transmitters 10 in the first exemplary embodiment, it is not the only way. For example, it may also be determined to include a plurality of the optical transmitters 20 in the second exemplary embodiment. Alternatively, it may also be determined to include a plurality of the optical transmitters 40 in the third exemplary embodiment or a plurality of the optical transmitters 50 in the fourth exemplary embodiment.

Further, although it has been determined in the present exemplary embodiment that each of the optical transmitters 10₁ to 10_{M} includes a light source, it is not the only way. That is, it may be determined that the wavelength multiplexing transmission device 60 includes a wavelength tunable laser assembly which can switch the wavelength at high speed (ITLA: Integrable Tunable Laser Assembly). It may then be determined that light beams outputted from the wavelength tunable laser assembly, whose wavelengths are different from each other, are inputted to the optical transmitters 10₁ to 10_{M}. Similarly, although it has been determined in the present exemplary embodiment that each of the optical transmitters 10₁ to 10_{M} each includes the control unit, it is not the only way. That is, it may be determined that the wavelength multiplexing transmission device 60 includes a single control unit, and the control unit controls the first and the second modulation units of each of the optical transmitters 10₁ to 10_{M}.

Although the exemplary embodiments according to the present invention have been described above with reference to the drawings, it is obvious that the present invention is not limited to the exemplary embodiments. The forms, combinations and the like of the constituent elements shown in the exemplary embodiments described above are just examples, and they can be modified in various ways on the basis of a design demand and the like within the range without departing from the spirit of the present invention.

Further, it is obvious that the first to the fifth exemplary embodiments can be achieved by providing a communication terminal with a recording medium in which the program code of software to realize the functions of the exemplary embodiments, and by a computer in the communication terminal which reads out and executes the program code stored in the recording medium.

Here, the recording medium for providing the program may be any medium capable of recording the above-mentioned program, for example, a CD-ROM (Compact Disc Read Only Memory), a DVD-R (Digital Versatile Disk Recordable), an optical disc, a magnetic disk, a non-volatile memory card and the like.

The whole or part of the above-described exemplary embodiments disclosed above can be described as, but is not limited to, the following supplementary notes.

(Supplementary note 1) An optical transmitter comprising: a modulator; an output light monitoring unit; and a control unit, wherein

said modulator comprises: a dividing unit which divides light inputted to said modulator into first branch light and second branch light; a first modulation unit which performs phase modulation for said first branch light; a second modulation unit which performs phase modulation for said second branch light; a rotator which rotates the polarization plane of one of first modulated light outputted from said first modulation unit and second modulated light outputted from said second modulation unit; and a polarization combining unit which combines said first modulated light and said second modulated light;

said output light monitoring unit monitors light intensity of the combined light outputted from said polarization combining unit; and

said control unit controls at least one of said first modulation unit and said second modulation unit, on the basis of a monitoring result by said output light monitoring unit, wherein said control comprises a light intensity control for making at least one of the light intensity of said first modulated light and that of said second modulated light smaller than a maximum value of the light intensity on a modulation curve.

(Supplementary note 2) The optical transmitter according to supplementary note 1, wherein said output light monitoring unit further monitors the light intensity of said first modulated light and that of said second modulated light.
(Supplementary note 3) The optical transmitter according to supplementary note 2, further comprising:

a first photoelectric conversion element into which branch light of output light from said first modulation unit is inputted,

a second photoelectric conversion element into which branch light of output light from said second modulation unit is inputted, and

a third photoelectric conversion element into which branch light of output light from said polarization combining unit is inputted,

wherein said output light monitoring unit monitors the light intensity of each of said first modulated light, said second modulated light and said combined light, on the basis of outputs from said first to third photoelectric conversion elements.

(Supplementary note 4) The optical transmitter according to supplementary note 2, further comprising:

a first photoelectric conversion element into which branch light of output light from said first modulation unit is inputted,

a second photoelectric conversion element into which branch light of output light from said second modulation unit is inputted, and

a recording unit which records information on the amount of optical loss for each of said first modulated light and said second modulated light, wherein

said output light monitoring unit monitors the light intensity of each of said first modulated light, said second modulated light and said combined light, on the basis of outputs from said first and second photoelectric conversion elements and the information on said amounts of optical loss recorded in said recording unit.

(Supplementary note 5) The optical transmitter according to supplementary note 4, wherein

said information on the amounts of optical loss comprises at least information on the quantum efficiency of said first photoelectric conversion element, on the quantum efficiency of said second photoelectric conversion element and on the insertion loss of said polarization combining unit.

(Supplementary note 6) The optical transmitter according to any one of supplementary notes 1 to 5, further comprising:

a driving unit which inputs driving signals to said first modulation unit and said second modulation unit, and

a bias circuit which applies bias voltages to said first modulation unit and said second modulation unit, wherein

said control unit performs said light intensity control by controlling the magnitudes of the bias voltages outputted by said bias circuit.

(Supplementary note 7) The optical transmitter according to supplementary note 6, wherein

said control unit controls the operational points of said bias voltages, on a modulation curve, within a range of ±Vπ/4 (Vπ: the magnitude of a voltage capable of changing an optical phase by π on the modulation curve) from an operational point of the bias voltages at which the light intensity becomes maximized.

(Supplementary note 8) The optical transmitter according to any one of supplementary notes 1 to 5, further comprising:

a driving unit which inputs driving signals to said first modulation unit and said second modulation unit, and

a bias circuit which applies bias voltages to said first modulation unit and said second modulation unit, wherein

said control unit performs said light intensity control by controlling the amplitudes of the driving signals outputted by said driving unit.

(Supplementary note 9) The optical transmitter according to supplementary note 8, wherein

said control unit controls said amplitudes of the driving signals, on the modulation curve, within a range of ±Vπ/2 (VIE the magnitude of a voltage capable of changing an optical phase by π on the modulation curve) from an amplitude with which the light intensity becomes maximized.

(Supplementary note 10) The optical transmitter according to any one of supplementary notes 6 to 9, wherein

a pilot signal of a predetermined frequency is superposed on each of said bias voltages, and

said output light monitoring unit further monitors the phase of said pilot signal outputted from said first modulation unit and the phase of said pilot signal outputted from said second modulation unit.

(Supplementary note 11) The optical transmitter according to supplementary note 10, wherein

said output light monitoring unit monitors the light intensity of said first modulated light by detecting the amplitude of said pilot signal outputted from said first modulation unit, and monitors the light intensity of said second modulated light by detecting the amplitude of said pilot signal outputted from said second modulation unit.

(Supplementary note 12) A wavelength multiplexing transmission device comprising a plurality of optical transmitters and a wavelength multiplexing unit which multiplexes wavelengths outputted from said plurality of optical transmitters respectively, wherein

each of said plurality of optical transmitters is an optical transmitter according to any one of supplementary notes 1 to 11.

(Supplementary note 13) The wavelength multiplexing transmission device according to supplementary note 12, further comprising a comparison unit to which a result of said output light monitoring in each of said plurality of optical transmitters is inputted, and in which a target value of the light intensity of said combined light in each of said plurality of optical transmitters is determined on the basis of said output light monitoring results.
(Supplementary note 14) An optical transmission method comprising:

a dividing process of dividing light into first branch light and second branch light;

a first modulation process of performing phase-modulation for said first branch light;

a second modulation process of performing phase-modulation for said second branch light;

a rotation process of rotating the polarization plane of one of first modulated light modulated by said first modulation process and second modulated light modulated by said second modulation process;

a polarization combining process of combining said first modulated light and said second modulated light;

a monitoring process of monitoring the light intensity of combined light produced by said polarization combining process;

and a control process of controlling at least one of a modulator for performing said first modulation process and a modulator for performing said second modulation process, on the basis of a monitoring result by said monitoring process, wherein

said control process comprises a light intensity control process of making at least one of the light intensity of said first modulated light and that of said second modulated light smaller than a maximum value of the light intensity on a modulation curve.

(Supplementary note 15) The optical transmission method according to supplementary note 14, wherein, in said monitoring process, the light intensity of said first modulated light and that of said second modulated light are further monitored.
(Supplementary note 16) The optical transmission method according to supplementary note 15, further comprising:

a first photoelectric conversion process of performing photoelectric conversion of part of said first modulated light,

a second photoelectric conversion process of performing photoelectric conversion of part of said second modulated light, and

a third photoelectric conversion process of performing photoelectric conversion of part of said combined light, wherein,

in said monitoring process, on the basis of electrical signals generated by said first to third photoelectric conversion processes, the light intensity of each of said first modulated light, said second modulated light and said combined light is monitored.

(Supplementary note 17) The optical transmission method according to supplementary note 15, further comprising:

a first photoelectric conversion process of performing photoelectric conversion of part of said first modulated light,

a second photoelectric conversion process of performing photoelectric conversion of part of said second modulated light, and

a recording process of recording information on the amount of optical loss for each of said first modulated light and said second modulated light, wherein, in said monitoring process, on the basis of electrical signals generated by said first and second photoelectric conversion processes and of said information on the amounts of optical loss recorded by said recording process, the light intensity of each of said first modulated light, said second modulated light and said combined light is monitored.

(Supplementary note 18) The optical transmission method according to supplementary note 17, wherein

said information on the amounts of optical loss comprises at least information on the amounts of optical loss occurring in said first photoelectric conversion process, that occurring in said second photoelectric conversion process and that occurring in said polarization combining process.

(Supplementary note 19) The optical transmission method according to any one of supplementary notes 14 to 18, wherein,

in said control process, said light intensity control is performed by controlling the magnitudes of bias voltages applied to a first modulation unit for performing said first modulation process and a second modulation unit for performing said second modulation process.

(Supplementary note 20) The optical transmission method according to supplementary note 19, wherein,

in said control process, the operational points of said bias voltages are controlled, on a modulation curve, within a range of ±Vπ/4 (Vπ: the magnitude of a voltage capable of changing an optical phase by π on the modulation curve) from an operational point of the bias voltages at which the light intensity becomes maximized.

(Supplementary note 21) The optical transmission method according to any one of supplementary notes 14 to 18, wherein,

in said control process, said light intensity control is performed by controlling the amplitudes of driving signals inputted to the first modulation unit for performing said first modulation process and the second modulation unit for performing said second modulation process.

(Supplementary note 22) The optical transmission method according to supplementary note 21, wherein,

in said control process, said amplitudes of the driving signals are controlled, on the modulation curve, within a range of ±Vπ/2 (Vπ: the magnitude of a voltage capable of changing an optical phase by π on the modulation curve) from an amplitude with which the light intensity becomes maximized.

(Supplementary note 23) The optical transmission method according to any one of supplementary notes 19 to 22, wherein

a pilot signal of a predetermined frequency is superposed on each of bias voltages applied to the first modulation unit for performing said first modulation process and the second modulation unit for performing said second modulation process, and,

in said monitoring process, further monitored are the phase of said pilot signal outputted from said first modulation unit and the phase of said pilot signal outputted from said second modulation unit.

(Supplementary note 24) The optical transmission method according to supplementary note 23, wherein,

in said monitoring process, the light intensity of said first modulated light is monitored by detecting the amplitude of said pilot signal outputted from said first modulation unit, and the light intensity of said second modulated light is monitored by detecting the amplitude of said pilot signal outputted from said second modulation unit.

(Supplementary note 25) A wavelength multiplexing transmission method comprising a wavelength multiplexing process of multiplexing light beams having wavelengths different from each other, wherein

said light beams having wavelengths different from each other are each transmitted by an optical transmission method according to any one of supplementary notes 14 to 24.

(Supplementary note 26) A program for causing a computer to execute:

a monitoring process of monitoring the light intensity of combined light of first modulated light produced by phase modulation for first branch light and second modulated light, which is produced by phase modulation for second branch light and is of a different polarization plane from that of said first modulated light; and

a control process of controlling at least one of said phase modulation for the first branch light and said phase modulation for the second branch light, on the basis of a monitoring result by said monitoring process, wherein

said control process comprises a light intensity control process of making at least one of the light intensity of said first modulated light and that of said second modulated light smaller than a maximum value of the light intensity on a modulation curve.

(Supplementary note 27) A computer-readable information recording medium for recording the program according to supplementary note 26.

Although the present invention has been described above with reference to the exemplary embodiments, the present invention is not limited to the above-described exemplary embodiments. Various modifications which can be understood by those skilled in the art can be made to the configurations and details of the present invention within the scope of the present invention.

This application is based upon and claims the benefit of priority from Japanese Patent Application No. 2011-67700, filed on Mar. 25, 2011, the disclosure of which is incorporated herein in its entirety by reference.

### DESCRIPTION OF THE CODES

10, 10₁ to 10_{M}, 20, 40 optical transmitter
11, 22 modulator
12, 23 output light monitoring unit
13, 24 control unit
14, 28 dividing unit
15, 29 first modulation unit
16, 30 second modulation unit
17, 31 rotator
18, 32 polarization combining unit
21 light source
25 bias circuit
26 driving circuit
27 external photoelectric element
33 first internal photoelectric element
34 second internal photoelectric element
35₁ to 35₄ phase shifting unit
36 internal output light monitoring unit
37 external output light monitoring unit
41 recording unit
60 wavelength multiplexing transmission device
61 wavelength multiplexing unit
62 comparison unit

1. An optical transmitter comprising:
a modulator; an output light monitoring unit; and a control unit, wherein
said modulator comprises
a dividing unit which divides light inputted to said modulator into first branch light and second branch light;
a first modulation unit which performs phase modulation for said first branch light;
a second modulation unit which performs phase modulation for said second branch light;
a rotator which rotates the polarization plane of one of first modulated light outputted from said first modulation unit and second modulated light outputted from said second modulation unit; and
a polarization combining unit which combines said first modulated light and said second modulated light;
said output light monitoring unit monitors optical intensity of the combined light outputted from said polarization combining unit; and
said control unit controls at least one of said first modulation unit and said second modulation unit, on the basis of a monitoring result by said output light monitoring unit, wherein
said control comprises an optical intensity control for making at least one of the optical intensity of said first modulated light and that of said second modulated light smaller than a maximum value of the optical intensity on a modulation curve.

2. The optical transmitter according to claim 1, wherein
said output light monitoring unit further monitors the optical intensity of said first modulated light and that of said second modulated light.

3. The optical transmitter according to claim 2, further comprising:
a first photoelectric conversion element into which branch light of output light from said first modulation unit is inputted,
a second photoelectric conversion element into which branch light of output light from said second modulation unit is inputted, and
a third photoelectric conversion element into which branch light of output light from said polarization combining unit is inputted, wherein
said output light monitoring unit monitors the optical intensity of each of said first modulated light, said second modulated light and said combined light, on the basis of outputs from said first to third photoelectric conversion elements.

4. The optical transmitter according to claim 2, further comprising:
a first photoelectric conversion element into which branch light of output light from said first modulation unit is inputted,
a second photoelectric conversion element into which branch light of output light from said second modulation unit is inputted, and
a recording unit which records information on the amount of optical loss for each of said first modulated light and said second modulated light, wherein
said output light monitoring unit monitors the optical intensity of each of said first modulated light, said second modulated light and said combined light, on the basis of outputs from said first and second photoelectric conversion elements and the information on said amounts of optical loss recorded in said recording unit.

5-10. (canceled)

11. The optical transmitter according to claim 4, wherein
said information on the amounts of optical loss comprises at least information on the quantum efficiency of said first photoelectric conversion element, on the quantum efficiency of said second photoelectric conversion element and on the insertion loss of said polarization combining unit.

12. The optical transmitter according to claim 1, further comprising:
a driving unit which inputs driving signals to said first modulation unit and said second modulation unit, and
a bias circuit which applies bias voltages to said first modulation unit and said second modulation unit, wherein
said control unit performs said optical intensity control by controlling the magnitudes of the bias voltages outputted by said bias circuit.

13. The optical transmitter according to claim 12, wherein
said control unit controls the operational points of said bias voltages, on a modulation curve, within a range of ±Vπ/4 (Vπ: the magnitude of a voltage capable of changing an optical phase by n on the modulation curve) from an operational point of the bias voltages at which the optical intensity becomes maximized.

14. The optical transmitter according to claim 1, further comprising:
a driving unit which inputs driving signals to said first modulation unit and said second modulation unit, and
a bias circuit which applies bias voltages to said first modulation unit and said second modulation unit, wherein
said control unit performs said optical intensity control by controlling the amplitudes of the driving signals outputted by said driving unit.

15. The optical transmitter according to claim 14, wherein
said control unit controls said amplitudes of the driving signals, on the modulation curve, within a range of ±Vπ/2 (Vπ: the magnitude of a voltage capable of changing an optical phase by n on the modulation curve) from an amplitude with which the optical intensity becomes maximized.

16. The optical transmitter according to claim 12, wherein
a pilot signal of a predetermined frequency is superposed on each of said bias voltages, and
said output light monitoring unit further monitors the phase of said pilot signal outputted from said first modulation unit and the phase of said pilot signal outputted from said second modulation unit.

17. The optical transmitter according to claim 16, wherein
said output light monitoring unit monitors the optical intensity of said first modulated light by detecting the amplitude of said pilot signal outputted from said first modulation unit, and monitors the optical intensity of said second modulated light by detecting the amplitude of said pilot signal outputted from said second modulation unit.

18. A wavelength multiplexing transmission device comprising:
a plurality of optical transmitters; and
a wavelength multiplexing unit which multiplexes wavelengths outputted from said plurality of optical transmitters respectively, wherein
each of said plurality of optical transmitters is an optical transmitter according to claim 1.

19. The wavelength multiplexing transmission device according to claim 18, further comprising a comparison unit to which a result of said output light monitoring in each of said plurality of optical transmitters is inputted, and in which a target value of the optical intensity of said combined light in each of said plurality of optical transmitters is determined on the basis of said output light monitoring results.

20. An optical transmission method comprising:
a dividing process of dividing light into first branch light and second branch light;
a first modulation process of performing phase-modulation for said first branch light;
a second modulation process of performing phase-modulation for said second branch light;
a rotation process of rotating the polarization plane of one of first modulated light modulated by said first modulation process and second modulated light modulated by said second modulation process;
a polarization combining process of combining said first modulated light and said second modulated light;
a monitoring process of monitoring the optical intensity of combined light produced by said polarization combining process;
and a control process of controlling at least one of a modulator for performing said first modulation process and a modulator for performing said second modulation process, on the basis of a monitoring result by said monitoring process, wherein
said control process comprises an optical intensity control process of making at least one of the optical intensity of said first modulated light and that of said second modulated light smaller than a maximum value of the optical intensity on a modulation curve.

21. The optical transmission method according to claim 20, wherein, in said monitoring process, the optical intensity of said first modulated light and that of said second modulated light are further monitored.

22. The optical transmission method according to claim 21, further comprising:
a first photoelectric conversion process of performing photoelectric conversion of part of said first modulated light,
a second photoelectric conversion process of performing photoelectric conversion of part of said second modulated light, and
a third photoelectric conversion process of performing photoelectric conversion of part of said combined light, wherein,
in said monitoring process, on the basis of electrical signals generated by said first to third photoelectric conversion processes, the optical intensity of each of said first modulated light, said second modulated light and said combined light is monitored.

23. The optical transmission method according to claim 21, further comprising:
a first photoelectric conversion process of performing photoelectric conversion of part of said first modulated light,
a second photoelectric conversion process of performing photoelectric conversion of part of said second modulated light, and
a recording process of recording information on the amount of optical loss for each of said first modulated light and said second modulated light, wherein, in said monitoring process, on the basis of electrical signals generated by said first and second photoelectric conversion processes and of said information on the amounts of optical loss recorded by said recording process, the optical intensity of each of said first modulated light, said second modulated light and said combined light is monitored.

24. The optical transmission method according to claim 23, wherein
said information on the amounts of optical loss comprises at least information on the amounts of optical loss occurring in said first photoelectric conversion process, that occurring in said second photoelectric conversion process and that occurring in said polarization combining process.

25. A program which makes a computer execute
a monitoring process of monitoring the optical intensity of combined light of first modulated light produced by phase modulation for first branch light and second modulated light, which is produced by phase modulation for second branch light, whose polarization plane is different from that of said first modulated light; and
a control process of controlling at least one of said phase modulation for the first branch light and said phase modulation for the second branch light, on the basis of a monitoring result by said monitoring process, wherein
said control process comprises an optical intensity control process of making at least one of the optical intensity of said first modulated light and that of said second modulated light smaller than a maximum value of the optical intensity on a modulation curve.

26. A computer-readable information recording medium for recording the program according to claim 25.
